(19) United States
(12) Patent Application Publication
(10) Pub. No.: US 2023/0354073 A1
(43) Pub. Date: Nov. 2, 2023

(54) CROSS-LINK INTERFERENCE REPORTING ON PHYSICAL UPLINK CHANNELS

(71) Applicant: QUALCOMM Incorporated, San Diego, CA (US)

(72) Inventors: Abdelrahman Mohamed Ahmed Mohamed Ibrahim, San Diego, CA (US); Muhammad Sayed Khairy Abdelghaffar, San Jose, CA (US); Huilin Xu, Temecula, CA (US); Ahmed Attia Abotabl, San Diego, CA (US); Seyedkianoush Hosseini, San Diego, CA (US)

(21) Appl. No.: 17/732,008

(22) Filed: Apr. 28, 2022

(51) Int. Cl. H04W 24/10; H04W 72/08

(52) U.S. Cl. CPC H04W 24/10; H04W 72/085

(57) ABSTRACT

Methods, systems, and devices for wireless communications are described. A user equipment (UE) may receive a first message indicating a cross-link interference report configuration. The cross-link interference report configuration may be associated with a first set of rules for determining a quantity of resources for multiplexing a cross-link interference report on a physical uplink channel and a second set of rules for multiplexing the cross-link interference report on the physical uplink channel over the quantity of resources. The UE may transmit the cross-link interference report on the physical uplink channel in accordance with the first set of rules and the second set of rules. The cross-link interference report may indicate one or more cross-link interference measurements performed by the UE.

### FIELD OF TECHNOLOGY

The following relates to wireless communications, including cross-link interference (CLI) reporting on physical uplink channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, neighboring communication devices may transmit or receive communications concurrently, which my lead to cross-link interference (CLI).

### SUMMARY

The described techniques relate to improved methods, systems, devices, and apparatuses that support cross-link interference (CLI) reporting on physical uplink channels. Generally, the described techniques provide for configuring a communication device, such as a user equipment (UE), with one or more rules for performing CLI measurements and reporting. For example, the UE may receive a first message indicating a CLI report configuration. In some examples, the CLI report configuration may be associated with a first set of rules for determining a quantity of resources for multiplexing a CLI report on a physical uplink channel and a second set of rules for multiplexing the CLI report on the physical uplink channel over the quantity of resources. In some examples, the UE may transmit the CLI report on the physical uplink channel in accordance with the first set of rules and the second set of rules. The CLI report may indicate one or more CLI measurements performed by the UE. Transmitting the CLI report on the physical uplink channel in accordance with the first set of rules and the second set of rules may improve CLI reporting, thereby enhancing CLI mitigation techniques performed by the network.

A method for wireless communication at a UE is described. The method may include receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and transmitting the CLI report on the physical uplink channel in accordance with the first set of rules and the second set of rules, the CLI report indicating one or more CLI measurements performed by the UE.

An apparatus for wireless communication at a UE is described. The apparatus may include a processor, memory coupled with the processor, and instructions stored in the memory. The instructions may be executable by the processor to cause the apparatus to receive a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and transmit the CLI report on the physical uplink channel in accordance with the first set of rules and the second set of rules, the CLI report indicating one or more CLI measurements performed by the UE.

Another apparatus for wireless communication at a UE is described. The apparatus may include means for receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and means for transmitting the CLI report on the physical uplink channel in accordance with the first set of rules and the second set of rules, the CLI report indicating one or more CLI measurements performed by the UE.

A non-transitory computer-readable medium storing code for wireless communication at a UE is described. The code may include instructions executable by a processor to receive a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and transmit the CLI report on the physical uplink channel in accordance with the first set of rules and the second set of rules, the CLI report indicating one or more CLI measurements performed by the UE.

Some examples of the method, apparatuses, and non-transitory computer-readable medium described herein may further include operations, features, means, or instructions for receiving a second message that triggers the UE to report the one or more CLI measurements and includes an offset indicator, where transmitting the CLI report may be based on receiving the second message and determining one or more CLI offset values based on the offset indicator, where the quantity of resources may be based on the one or more CLI offset values.

In some examples of the method, apparatuses, and non-transitory computer-readable medium described herein, determining the one or more CLI offset values may include operations, features, means, or instructions for determining the one or more CLI offset values using the offset indicator and a table including a set of multiple CLI offset values.

In some examples of the method, apparatuses, and non-transitory computer-readable medium described herein, determining the one or more CLI offset values may include operations, features, means, or instructions for calculating the one or more CLI offset values using a difference from one or more channel state information (CSI) offset values.

In some examples of the method, apparatuses, and non-transitory computer-readable medium described herein, the CLI report configuration includes an indication of the difference and calculating the one or more CLI offset values may be based on receiving the first message.

In some examples of the method, apparatuses, and non-transitory computer-readable medium described herein, the one or more CLI offset values may be different than one or more CSI offset values.

Some examples of the method, apparatuses, and non-transitory computer-readable medium described herein may further include operations, features, means, or instructions for receiving a second message that indicates one or more CLI offset values, where the quantity of resources may be based on the one or more CLI offset values and receiving a third message that triggers the UE to report the one or more CLI measurements, where the third message may be common to a group of two or more UEs including the UE, and where transmitting the CLI report may be based on receiving the third message.

In some examples of the method, apparatuses, and non-transitory computer-readable medium described herein, the third message includes an offset indicator and determining the one or more CLI offset values may be further based on the offset indicator.

Some examples of the method, apparatuses, and non-transitory computer-readable medium described herein may further include operations, features, means, or instructions for multiplexing the CLI report on the physical uplink channel over the quantity of resources based on the second set of rules, the physical uplink channel including a physical uplink shared channel (PUSCH), where transmitting the CLI report may be based on the multiplexing.

In some examples of the method, apparatuses, and non-transitory computer-readable medium described herein, multiplexing the CLI report may include operations, features, means, or instructions for multiplexing the CLI report subsequent to a CSI report.

In some examples of the method, apparatuses, and non-transitory computer-readable medium described herein, multiplexing the CLI report may include operations, features, means, or instructions for multiplexing a first portion of the CLI report subsequent to a first portion of a CSI report and multiplexing a second portion of the CLI report subsequent to a second portion of the CSI report.

Some examples of the method, apparatuses, and non-transitory computer-readable medium described herein may further include operations, features, means, or instructions for receiving a second message indicating for the UE to multiplex the CLI report with feedback information and multiplexing the CLI report with the feedback information based on receiving the second message, the physical uplink channel including a physical uplink control channel (PUCCH), where transmitting the CLI report may be based on the multiplexing.

Some examples of the method, apparatuses, and non-transitory computer-readable medium described herein may further include operations, features, means, or instructions for receiving a third message indicating for the UE to multiplex the CLI report with a CSI report, where multiplexing the CLI report with the feedback information includes and multiplexing the CLI report with the feedback information and the CSI report based on receiving the second message and the third message.

In some examples of the method, apparatuses, and non-transitory computer-readable medium described herein, the CLI report may be multiplexed subsequent to the feedback information and a first portion of the CSI report.

In some examples of the method, apparatuses, and non-transitory computer-readable medium described herein, multiplexing the CLI report with the feedback information and the CSI report may include operations, features, means, or instructions for multiplexing the CLI report with the feedback information and the CSI report in accordance with an ordering that may be based on a respective priority of the CLI report and the CSI report.

In some examples of the method, apparatuses, and non-transitory computer-readable medium described herein, multiplexing the CLI report with the feedback information and the CSI report may include operations, features, means, or instructions for multiplexing the feedback information, a first portion of the CSI report, and a first portion of the CLI report and dropping at least a second portion of the CLI report.

A method for wireless communication at a network entity is described. The method may include transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and receiving the CLI report on the physical uplink channel in accordance with the first set of rules and the second set of rules, the CLI report indicating one or more CLI measurements performed by a UE.

An apparatus for wireless communication at a network entity is described. The apparatus may include a processor, memory coupled with the processor, and instructions stored in the memory. The instructions may be executable by the processor to cause the apparatus to transmit a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and receive the CLI report on the physical uplink channel in accordance with the first set of rules and the second set of rules, the CLI report indicating one or more CLI measurements performed by a UE.

Another apparatus for wireless communication at a network entity is described. The apparatus may include means for transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and means for receiving the CLI report on the physical uplink channel in accordance with the first set of rules and the second set of rules, the CLI report indicating one or more CLI measurements performed by a UE.

A non-transitory computer-readable medium storing code for wireless communication at a network entity is described. The code may include instructions executable by a processor to transmit a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources and receive the CLI report on the physical uplink channel in accordance with the first set of rules and the second set of rules, the CLI report indicating one or more CLI measurements performed by a UE.

Some examples of the method, apparatuses, and non-transitory computer-readable medium described herein may further include operations, features, means, or instructions for transmitting a second message that triggers the UE to report the one or more CLI measurements and includes an offset indicator, where receiving the CLI report may be based on receiving the second message, and where the quantity of resources may be based on one or more CLI offset values indicated by the offset indicator.

In some examples of the method, apparatuses, and non-transitory computer-readable medium described herein, the one or more CLI offset values indicated by the offset indicator correspond to CLI offset values included in a table.

In some examples of the method, apparatuses, and non-transitory computer-readable medium described herein, the one or more CLI offset values indicated by the offset indicator may be based on a difference from one or more CSI offset values.

In some examples of the method, apparatuses, and non-transitory computer-readable medium described herein, the CLI report configuration includes an indication of the difference.

In some examples of the method, apparatuses, and non-transitory computer-readable medium described herein, the one or more CLI offset values may be different than one or more CSI offset values.

Some examples of the method, apparatuses, and non-transitory computer-readable medium described herein may further include operations, features, means, or instructions for transmitting a second message that indicates one or more CLI offset values, where the quantity of resources may be based on the one or more CLI offset values and transmitting a third message that triggers the UE to report the one or more CLI measurements, where the third message may be common to a group of two or more UEs including the UE, and where receiving the CLI report may be based on the third message.

In some examples of the method, apparatuses, and non-transitory computer-readable medium described herein, the third message includes an offset indicator and the one or more CLI offset values may be based on the offset indicator.

In some examples of the method, apparatuses, and non-transitory computer-readable medium described herein, the CLI report may be multiplexed on the physical uplink channel over the quantity of resources subsequent to a CSI report and based on the second set of rules.

In some examples of the method, apparatuses, and non-transitory computer-readable medium described herein, a first portion of the CLI report may be multiplexed on the physical uplink channel over the quantity of resources subsequent to a first portion of a CSI report and based on the second set of rules and a second portion of the CLI report may be multiplexed on the physical uplink channel over the quantity of resources subsequent to a second portion of the CSI report.

Some examples of the method, apparatuses, and non-transitory computer-readable medium described herein may further include operations, features, means, or instructions for transmitting a second message indicating for the UE to multiplex the CLI report with feedback information, where the CLI report may be multiplexed with the feedback information based on the second message.

Some examples of the method, apparatuses, and non-transitory computer-readable medium described herein may further include operations, features, means, or instructions for transmitting a third message indicating for the UE to multiplex the CLI report with a CSI report, where the CLI report may be multiplexed with the feedback information and the CSI report based on the third message.

In some examples of the method, apparatuses, and non-transitory computer-readable medium described herein, the CLI report may be multiplexed subsequent to the feedback information and a first portion of the CSI report.

In some examples of the method, apparatuses, and non-transitory computer-readable medium described herein, the CLI report may be multiplexed with the feedback information and the CSI report according to an ordering that may be based on a respective priority of the CLI report and the CSI report.

In some examples of the method, apparatuses, and non-transitory computer-readable medium described herein, the feedback information, a first portion of the CSI report, and a first portion of the CLI report may be multiplexed on the physical uplink channel and at least a portion of a second portion of the CLI report may be dropped.

### BRIEF DESCRIPTION OF THE DRAWINGS

FIGS. 1, 2A, 2B, and 2C each illustrate an example of a wireless communications system that supports cross-link interference (CLI) reporting on physical uplink channels in accordance with one or more aspects of the present disclosure.

FIGS. 3A and 3B each illustrate an example of a full-duplex operation scheme that supports CLI reporting on physical uplink channels in accordance with one or more aspects of the present disclosure.

FIG. 4 illustrates an example of a resource mapping that supports CLI reporting on physical uplink channels in accordance with one or more aspects of the present disclosure.

FIG. 5 illustrates an example of a process flow in a system that supports CLI reporting on physical uplink channels in accordance with one or more aspects of the present disclosure.

FIGS. 6 and 7 show block diagrams of devices that support CLI reporting on physical uplink channels in accordance with one or more aspects of the present disclosure.

FIG. 8 shows a block diagram of a communications manager that supports CLI reporting on physical uplink channels in accordance with one or more aspects of the present disclosure.

FIG. 9 shows a diagram of a system including a device that supports CLI reporting on physical uplink channels in accordance with one or more aspects of the present disclosure.

FIGS. 10 and 11 show block diagrams of devices that support CLI reporting on physical uplink channels in accordance with one or more aspects of the present disclosure.

FIG. 12 shows a block diagram of a communications manager that supports CLI reporting on physical uplink channels in accordance with one or more aspects of the present disclosure.

FIG. 13 shows a diagram of a system including a device that supports CLI reporting on physical uplink channels in accordance with one or more aspects of the present disclosure.

FIGS. 14 through 19 show flowcharts illustrating methods that support CLI reporting on physical uplink channels in accordance with one or more aspects of the present disclosure.

### DETAILED DESCRIPTION

In some wireless communications systems, a communication device, such as a user equipment (UE) or a network entity, may support wireless communications over one or multiple radio access technologies. Examples of radio access technologies may include fourth generation (4G) systems, such as Long Term Evolution (LTE) systems, and fifth generation (5G) systems, which may be referred to as NR systems. In such cases, the communication device may operate in a half-duplex mode or a full-duplex mode, or a combination thereof. In a half-duplex mode, the communication device may either transmit communications or receive communications during a time period, such as a transmission time interval (TTI) that may span one or more time resources (e.g., symbols, mini-slots, slots, etc.). In a full-duplex mode, the communication device may simultaneously transmit and receive communications during the time period. That is, communications received by the communication device may overlap in the time domain with communications transmitted by the communication device. For example, symbols occupied by received signals may overlap with symbols occupied by transmitted signals.

In some examples, neighboring communication devices (e.g., UEs, network entities, or the like) may perform full-duplex communications or half-duplex time division duplexing (TDD) concurrently, such that communications received by a first communication device may overlap in time with communications transmitted by a second communication device (e.g., a neighboring communication device). In such an example, the communications transmitted by the second communication device may interfere with the communications received at the first communication device. Put another way, because a full-duplex-capable communication device may receive signaling at the same time the communication device is transmitting, the communication device may, in some cases, be impacted by relatively increased amounts of interference from other, nearby transmitting devices (e.g., as compared to communicating using half-duplex techniques). Such interference may be referred to as cross-link interference (CLI) or other similar terminology. In some examples, CLI may degrade wireless communications between the first communication device and the network. Therefore, to mitigate effects of CLI, the network may configure the first communication device to measure and report CLI.

In some examples, the network may configure a communication device (e.g., a UE) to perform CLI reporting via higher layer (e.g., L3, radio resource control (RRC) layer) signaling. To increase the flexibility of CLI reporting, the network may configure the communication device to measure and report CLI, where the CLI may be reported via lower-layer (e.g., L1, physical (PHY) layer) signaling. For example, the communication device may report CLI via a channel state information (CSI) report. In some examples, however, including CLI within a CSI report may limit the reporting of CLI to instances when CSI is also reported.

Various aspects of the present disclosure generally relate to techniques for CLI reporting on physical uplink channels (e.g., a physical uplink shared channel (PUSCH), a physical uplink control channel (PUCCH)), and more specifically, to techniques for configuring a communication device with one or more rules for performing CLI reporting on one or more physical uplink channels. For example, to reduce signaling overhead for the communication device, the network may configure the communication device with one or more rules for multiplexing a CLI report on a physical uplink channel (e.g., as uplink control information separate from a CSI report). The network may configure the communication device to report CLI on a PUSCH or on a PUCCH.

For example, the network may configure the communication device with one or more parameters for determining a quantity of resources for multiplexing the CLI report on the PUSCH. In some examples, the network may indicate the parameters to the communication device via semi-static signaling (e.g., via an RRC message) or dynamic signaling (e.g., via a dedicated downlink control information (DCI) or a group-common DCI), or both. In some examples, the network may use the dynamic signaling to trigger the communication device to perform CLI reporting. Additionally, or alternatively, the network may configure the communication device with one or more rules for multiplexing the CLI report on the PUSCH (e.g., over the determined quantity of resources). For instance, the network may configure the communication device to determine whether to multiplex the CLI report on the PUSCH with a CSI report based on a relative priority of the CLI report and the CSI report.

Additionally, or alternatively, the network may configure the communication device with one or more rules for determining whether to multiplex the CLI report on the PUCCH with other uplink control information, such as downlink feedback information (e.g., hybrid automatic repeat request acknowledgment (HARQ-ACK) information), a CSI report, or both. For example, the network may configure the communication device to multiplex the CLI report with the downlink feedback information or the CSI report (or both) based on one or more indicators and a relative priority of the CLI report and the CSI report.

Particular aspects of the subject matter described herein may be implemented to realize one or more of the following potential advantages. The techniques employed by the described communication devices may provide benefits and enhancements to the operation of the communication devices, including enabling the configuration of a communication device with one or more rules for performing CLI reporting on physical uplink channels. Further, techniques for CLI reporting on physical uplink channels, as described herein, may support higher data rates, spectrum efficiency enhancement, and efficient resource utilization, thereby improving throughput and reliability. Such techniques may therefore lead to improved network operations and network efficiencies, among other benefits.

Aspects of the disclosure are initially described in the context of wireless communications systems. Aspects of the disclosure are also described in the context of operations schemes, a resource mapping, and a process flow. Aspects of the disclosure are further illustrated by and described with reference to apparatus diagrams, system diagrams, and flowcharts that relate to CLI reporting on physical uplink channels.

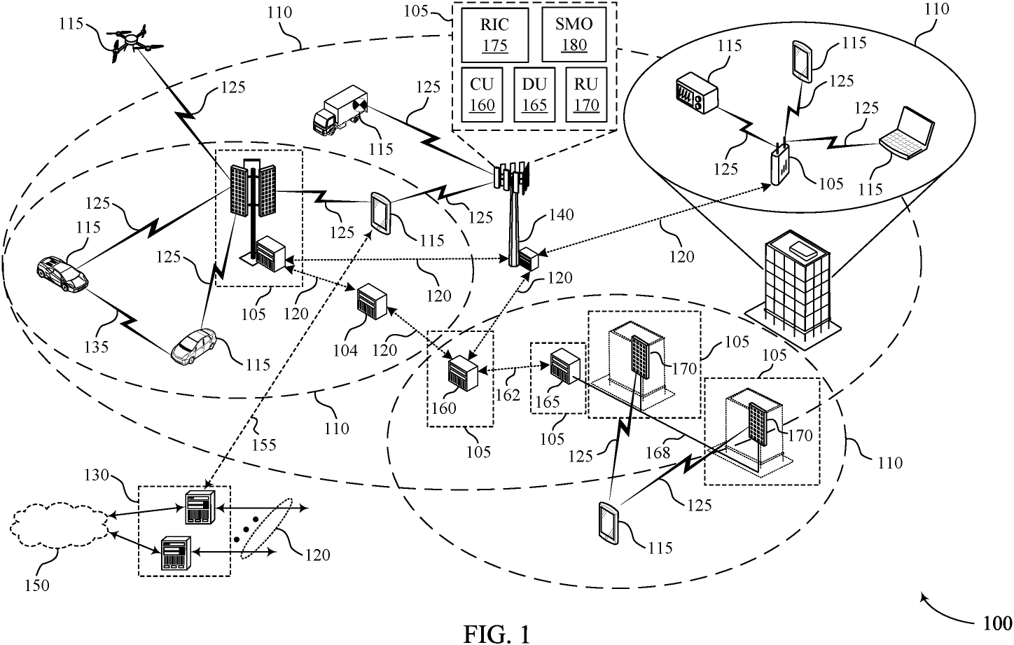

FIG. 1 illustrates an example of a wireless communications system 100 that supports CLI reporting on physical uplink channels in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support CLI reporting on physical uplink channels as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ = 1/(Δ ƒₘₐₓ · N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The wireless communications system 100 may support techniques for configuring a communication device (e.g., a UE 115) with one or more rules for performing CLI reporting on physical uplink channels. For example, the UE 115 may receive a first message indicating a CLI report configuration. In some examples, the CLI report configuration may be associated with a first set of rules for determining a quantity of resources for multiplexing a CLI report on a physical uplink channel and a second set of rules for multiplexing the CLI report on the physical uplink channel over the quantity of resources. In some examples, the UE 115 may transmit the CLI report on the physical uplink channel in accordance with the first set of rules and the second set of rules. The CLI report may indicate one or more CLI measurements performed by the UE. In some examples, by transmitting the CLI report to the network in accordance with the described techniques, the UE 115 may provide one or more enhancements to CLI mitigation techniques performed by the network, among other benefits.

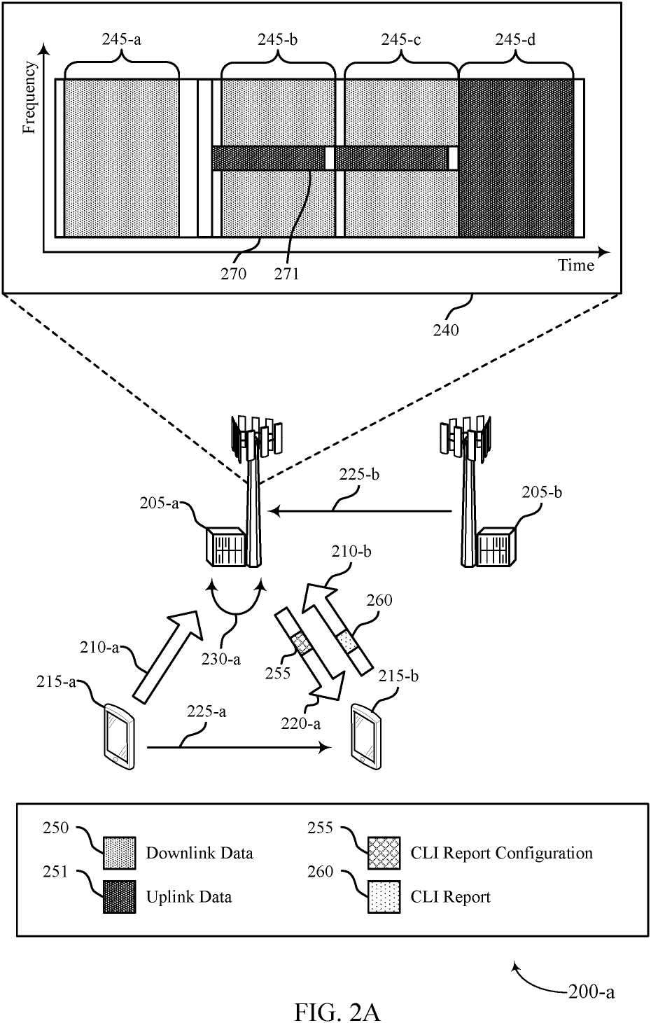

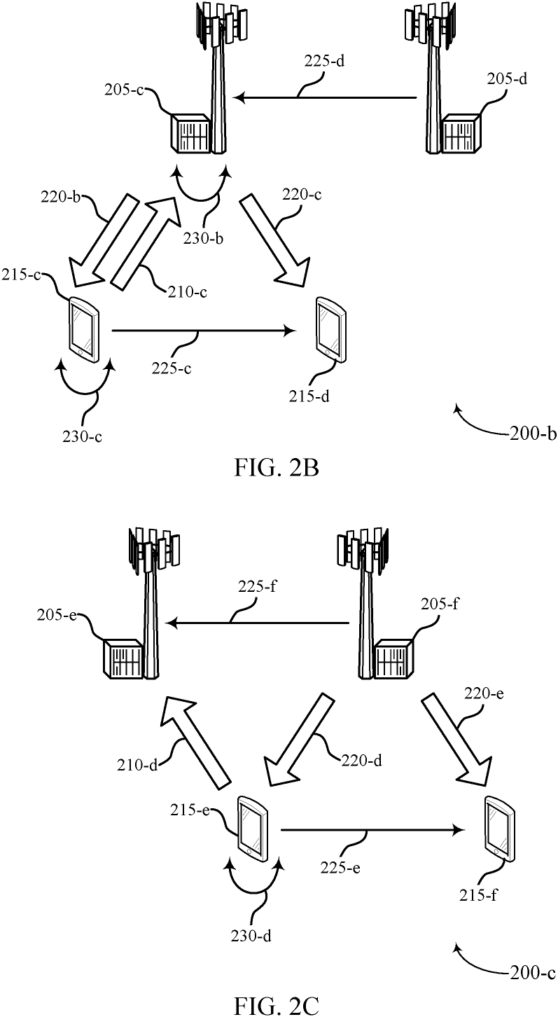

FIGS. 2A, 2B, and 2C each illustrate an example of a wireless communications system 200 that supports CLI reporting on physical uplink channels in accordance with one or more aspects of the present disclosure. In some examples, the wireless communications systems 200 (e.g., a wireless communications system 200-a, a wireless communications system 200-b, and a wireless communications system 200-c) may implement aspects of the wireless communications system 100. For example, the wireless communications systems 200 may each include one or more network entities 205 (e.g., a network entity 205-a, a network entity 205-b, a network entity 205-c, a network entity 205-d, a network entity 205-e, and a network entity 205-f) and one or more UEs 215 (e.g., a UE 215-a, a UE 215-b, a UE 215-c, a UE 215-d, a UE 215-e, and a UE 215-f), which may be examples of the corresponding devices as described with reference to FIG. 1. In the example of FIGS. 2A, 2B, and 2C, the network entities 205 may be examples of a CU 160, a DU 165, an RU 170, a base station 140, an IAB node 104, or one or more other network nodes as described with reference to FIG. 1. The wireless communications systems 200 may include features for improved communications between the UEs 215 and the network, among other benefits.

In the examples of FIGS. 2A, 2B, and 2C, the UEs 215 and the network entities 205 may communicate via one or more communication links 210 (e.g., a communication link 210-a, a communication link 210-b, a communication link 210-c, and a communication link 210-d) and via one or more communication links 220 (e.g., a communication link 220-a, a communication link 220-b, a communication link 220-c, a communication link 220-d, and a communication link 220-e). The communication links 210 may be examples of uplinks and the communication links 220 may be examples of downlinks. Additionally, or alternatively, the communication links 210 and the communication links 220 may each be examples of a communication link 125 as described with reference to FIG. 1. Each wireless communications system 200 may illustrate communication devices (e.g., one or more UEs 215, one or more network entities 205) operating in a full-duplex mode (e.g., performing full-duplex wireless communications) or a half-duplex TDD mode (e.g., performing half-duplex TDD wireless communications). That is, full-duplex (or half-duplex TDD) capabilities may be present at one or more network entities 205, one or more UEs 215 (or both). For example, the wireless communications systems 200 may support TDD radio frequency bands (e.g., radio frequency spectrum bands configured for TDD communications), FDD radio frequency bands (e.g., radio frequency spectrum bands configured for FDD communications), full-duplex communications at one or more network entities 205 (and/or one or more UEs 215), half-duplex communications at one or more UE 215, or any combination thereof.

Each wireless communications system 200 may support multiple types of full-duplex operations. For example, a communication device operating within the wireless communications systems 200 (e.g., a network entity 205, a UE 215) may support in-band full-duplex (IBFD) operations, sub-band FDD (SBFD) operations (e.g., frequency duplex operations), or both. In some examples of IBFD operations, the communication device may transmit and receive wireless communications on a same time and frequency resource (e.g., a same slot and component carrier bandwidth). For example, downlink communications and uplink communications may share time and frequency resources (e.g., IBFD time and frequency resources). In some examples, the time and frequency resources may partially overlap or fully overlap. Additionally, or alternatively, for SBFD operations, the communications device may transmit and receive communications at over a same time resource and one or more different frequency resources. That is, the downlink resources may be separated from the uplink resource in the frequency domain.

In the example of FIG. 2A, the network entity 205-a may support SBFD operations, such that downlink communications transmitted by the network entity 205-a (e.g., to the UE 215-b) may overlap in time with uplink communications received by the network entity 205-a (e.g., from the UE 215-a). In some examples, the network entity 205-a may configure communications for the UE 215-a and the UE 215-b according to the resource structure 240. The resource structure 240 may include time domain resources (e.g., slots, symbols) allocated for downlink data 250 (e.g., a time domain resource 245-a), time domain resources allocated for uplink data 251 (e.g., a time domain resource 245-d), and one or more time domain resources allocated for both downlink data 250 and uplink data 251 (e.g., a time domain resource 245-b and a time domain resource 245-c).

In some examples, the time domain resources allocated for both downlink data 250 and uplink data 251 (e.g., the time domain resource 245-b and the time domain resource 245-c) may be referred to as D+U slots (or D+U symbols). In some examples, a D+U slot may include half-duplex symbols (e.g., downlink symbols or uplink symbols) or full-duplex symbols (e.g., both downlink symbols and uplink symbols). For example, the time domain resource 245-b and the time domain resource 245-c (e.g., D+U slots) may be examples of slots, in which a radio frequency band is used for both transmitting uplink communications (e.g., uplink transmissions) and transmitting downlink communications (e.g., downlink transmissions). In some examples, the uplink transmissions and the downlink transmissions may occur in overlapping bands (e.g., for IBFD operations) or adjacent bands (e.g., for SBFD operations).

For SBFD operations in which uplink transmissions and downlink transmissions occur in adjacent bands, a half-duplex communication device may either transmit in an uplink radio frequency band or receive in a downlink radio frequency band. That is, for a given time domain resource (e.g., for a given D+U slot or a given D+U symbol), such as the time domain resource 245-b, the half-duplex device (e.g., the UE 215-a, the UE 215-b) may transmit uplink data 251 (e.g., perform a PUSCH transmission) in the uplink radio frequency band 271 or receive downlink data 250 the downlink radio frequency band 270. For example, the UE 215-a may transmit uplink data 251 in the uplink radio frequency band 271, while the UE 215-b receives downlink data 250 the downlink radio frequency band 270.

Additionally, or alternatively, for SBFD operations in which uplink and downlink transmissions occur in adjacent bands, a full-duplex device may transmit in the uplink radio frequency band and receive in the downlink radio frequency band. That is, for a given time domain resource (e.g., for a given D+U slot or a given D+U symbol), such as the time domain resource 245-b, the full-duplex device may transmit uplink data 251 (e.g., perform a PUSCH transmission) in the uplink radio frequency band 271 and receive downlink data 250 the downlink radio frequency band 270. In the example of FIG. 2B, the UE 215-c (e.g., a full-duplex device) may transmit communications in an uplink radio frequency band, while receiving communications in a downlink radio frequency band (e.g., over a same D+U slot or a same D+U symbol).

In some examples, full-duplex communications may provide for latency reduction. For example, latency savings may be enabled by receiving downlink signal in uplink slots. Moreover, full-duplex communications may provide for spectrum efficiency enhancement (e.g., per cell or per UE), efficient resource utilization, and coverage extension, among other benefits. In some examples, however, full-duplex communications may lead to one or more types of interference, such as inter-cell interference (e.g., from neighboring communication devices), self-interference (e.g., for full-duplex communication devices), and CLI (e.g., inter-cell CLI or intra-cell CLI). For example, a communication device (e.g., one or more network entities 205, one or more UEs 215) may experience self-interference 230 (e.g., a self-interference 230-a, a self-interference 230-b, a self-interference 230-c, and a self-interference 230-d) between a pair of beams, such as a beam used for transmitting communications and a beam used die receiving communications. In some examples, self-interference may result from signal leakage between an antenna panel used to transmit communications and an antenna panel used to receive communications.

Additionally, or alternatively, neighboring communication devices (e.g., neighboring UEs 215, neighboring network entities 205) may perform full-duplex communications (or half-duplex TDD) concurrently, such that communications received by a first communication device may overlap in time with communications transmitted by a second communication device (e.g., a neighboring communication device). In such an example, the communications transmitted by the second communication device may interfere with the communications received at the first communication device. For example, the communications transmitted by the second communication device may lead to CLI at the first communications device. In some examples, CLI (e.g., CLI 225-a, CLI 225-b, CLI 225-c, CLI 225-d, CLI 225-e, or CLI 225-f) may result from energy leakage due to timing and frequency unalignment (e.g., misalignment) between the neighboring communication devices.

Additionally or alternatively CLI may result from automatic gain control (AGC) mismatch (e.g., misalignment). For example, as illustrated in the example of FIG. 2A, the AGC of the UE 215-b may be driven (e.g., controlled) by downlink communications from a serving cell (e.g., the network entity 205-a). In such an example, uplink communications transmitted from the UE 215-a may saturate the AGC of the UE 215-b, resulting in a misalignment (e.g., a loss of orthogonality) of the downlink communications received by the UE 215-b and the uplink communications transmitted by the UE 215-a. In some examples, the misalignment of the downlink communications and the uplink communications may lead to CLI 225-a at the UE 215-b.

In some examples, the network entity 205-a may be operating in a full-duplex mode (e.g., SBFD or IBFD) and the UEs 215 (e.g., the UE 215-a and the UE 215-b) may be operating in a half-duplex mode. For example, the network entity 205-a may receive uplink communications from the UE 215-a (e.g., via the communication link 210-a), while simultaneously transmitting downlink communications to a UE 215-b (e.g., via the communication link 220-a). In such an example, the full-duplex communications at the network entity 205-a may lead to self-interference 230-a. Additionally, or alternatively, the network entity 205-a and the network entity 205-b (e.g., neighboring network entities) may concurrently perform full-duplex communications, such that downlink signals transmitted by the network entity 205-b may overlap with uplink signals received by the network entity 205-a, leading to CLI 225-b.

Additionally, or alternatively, the UE 215-a and the UE 215-b (e.g., neighboring UEs) may concurrently perform half-duplex TDD communications such that uplink signals transmitted by the UE 215-b may overlap with downlink signals received by the UE 215-a, which may lead to CLI 225-a. In some examples, the UE 215-a may be operating in a cell different from the cell in which the UE 215-b may be operating. For example, the UE 215-a and the UE 215-b may be operating in adjacent cells. In an example, the CLI 225-a may be an example of inter-cell CLI. Additionally, or alternatively, the network entity 205-b may perform full-duplex communications concurrently with the network entity 205-a. In such an example, downlink communications transmitted by the network entity 205-b may lead to inter-cell interference at the UE 215-b. For example, the downlink communications transmitted by the network entity 205-b (e.g., to another UE (not shown)) may interfere with downlink communications received the UE 215-b (e.g., from the network entity 205-a).

In some other examples, the UE 215-a and the UE 215-b may be operating in a same cell. In such an example, the CLI 225-a may be an example of intra-cell CLI. For example, the network entity 205-a may be operating in a full-duplex mode (e.g., in SBFD), such that the network entity 205-a may configure downlink communications for the UE 215-a in frequency domain resources adjacent to the frequency domain resources allocated for uplink communications from the UE 215-b. For example, the network entity 205-a may configure the UE 215-b to receive downlink data 250 (e.g., from the network entity 205-a) in the time domain resource 245-b and in the downlink radio frequency band 270 and the UE 215-a may be configured to transmit uplink data 251 in the time domain resource 245-b in the uplink radio frequency band 271 (e.g., the adjacent frequency resources). In such an example, the uplink communications transmitted by the UE 215-a may interfere with the downlink communications received at the UE 215-b.

In the example of FIG. 2B, the network entity 205-c and the UE 215-c may each be operating in a full-duplex mode (e.g., IBDF), such that the UE 215-c may receive downlink communications from the network entity 205-c via the communication link 220-b, while simultaneously transmitting uplink communications to the network entity 205-c via the communication link 210-c. In such an example, the full-duplex communications at the network entity 205-c and the full-duplex communications at the UE 215-c may lead to self-interference 230-b and self-interference 230-c, respectively. In some examples of the wireless communications system 200-b, the UE 215-c and the UE 215-d may each be operating in a multiple transmission and reception mode. In such an example, downlink communications and uplink communications performed by the network entity 205-c may occur at two different antenna panels located at two transmission and reception points. For example, the reception of uplink communications from the UE 215-c a may occur at an antenna panel of a first transmission and reception point and the transmission of downlink communications to the UE 215-c may occur at an antenna panel of a second transmission and reception point. In some other examples, reception of the uplink communications and transmission of the downlink communications may occur at two co-located antenna panels of the network entity 205-c (e.g., a single base station).

In the example of FIG. 2C, the UE 215-e may be operating in a full-duplex mode (e.g., SBFD), such that the UE 215-e may receive downlink communications from the network entity 205-f via the communication link 220-d, while simultaneously transmitting uplink communications to the network entity 205-e via the communication link 210-d. In such an example, the full-duplex communications at the UE 215-e may lead to self-interference 230-d. In some examples of the wireless communications system 200-c, the network entity 205-e and the network entity 205-f may be examples of transmission and reception points and the UE 215-e (e.g., and the UE 215-f) may be operating in a multiple transmission and reception mode. In such an example, the uplink communications transmitted from the UE 215-e may lead to CLI 225-e (e.g., intra-cell CLI) at the UE 215-f.

In some examples, to reduce interference within the wireless communications systems 200, the network (e.g., one or more network entities 205) may employ one or more interference mitigation techniques. As illustrated in the example of FIG. 2A, the network may configure the UE 215-b to perform CLI measurement and reporting. In some examples, the network may configure the UE 215 to perform CLI measurement and reporting, where the reporting is transmitted via lower-layer (e.g., L1, PHY layer) signaling (e.g., via a lower-layer CLI framework). The L1 CLI framework may provide increased flexibility and enable the network to adapt to dynamic changes in CLI. In some examples of the L1 CLI framework, CLI measurement and reporting may be triggered via a DCI (e.g., a dedicated DCI or a group-common DCI). Additionally, or alternatively, for L1 CLI measurement and reporting, the network may configure the UE 215-a (e.g., the transmitting UE, the aggressor UE) with resources for transmitting reference signals to be measured by the UE 215-b. For example, the network may configure the UE 215-a with aperiodic, semi-persistent, or periodic resources (e.g., non-zero power sounding reference signal (SRS) resource) for transmitting the reference signals. Additionally, or alternatively, the network may configure the UE 215-b (e.g., the receiving UE, the victim UE) with resources for performing the CLI measurements on the reference signals transmitted by the UE 215-a. For example, the network may configure the UE 215-b with aperiodic, semi-persistent, or periodic CLI resources.

In some examples, the network entity 205-a and the UE 215-b may support sub-band based CLI measurement and reporting. Additionally, or alternatively, the network entity 205-a and the UE 215-b may support beam based CLI measurement and reporting. For example, the UE 215-b may determine a beam for performing CLI measurements based on a quasi co-location relationships (e.g., a quasi co-location relationship associated with spatial parameters of the receive beam, a type D quasi co-location relationship) between one or more beams (e.g., transmission configuration indicator (TCI) states) and the configured CLI measurement resources.

In some examples of CLI reporting via lower-layer signaling, the network may configure the UE 215-b to measure and report CLI using a CSI framework. For example, the network may configure the UE 215-b to include the CLI report as part of a CSI report. In some examples, the network may configure the UE 215-b to report the CLI as part of the CSI report via a higher layer parameter, such as a reportQuantity information element (IE). That is, the CSI framework may be extended to include the CLI report. In such an example, the CLI measurement resources may be based on interference measurement resources (or other resources allocated for CLI measurement). For example, the network may configure the CLI resources via a measurement resource configuration, such as for interference measurement resources with zero power SRS or CSI interference measurement. In some examples, the network may configure the UE 215-b via a dummy channel measurement resource, such that CLI measurement resources may be based on the interference measurement resources with zero power SRS or CSI interference measurement. It is to be understood that the names of IEs described herein may change based on implementation of one or multiple devices (e.g., the UE 215, the network entity 205, or both), and the examples described herein should not be considered limiting to the scope covered by the claims or the disclosure.

In some examples, if the network configures the UE 215-b to measure and report the CLI report via the CSI framework, the network may configure the UE 215-b to report CLI (e.g., the CLI 225-a) using a same one or more rules as may be used for reporting CSI. That is, if the network configures the UE 215-b to perform the CLI reporting as part of the CSI reporting framework, the network may configure the UE 215-b with (e.g., to follow) a same one or more multiplexing rules as may be used for the CSI.

For example, the network may configure the UE 215-b to map a CSI report (e.g., the uplink control information) on one or more uplink channels according to one or more mapping rules. Here, the network may configure the UE 215-b with one or more rules for mapping uplink control information, such as downlink feedback information or a CSI report (or both) on a PUSCH. In some examples, the network may configure the UE 215-b to map the feedback information (e.g., HARQ-ACK information) to resource elements around demodulation reference signal (DMRS) symbols. That is, modulated HARQ-ACK symbols may be mapped starting on an available (e.g., a first available) non-DMRS symbol after a DMRS symbol (e.g., a first DMRS symbol). In some examples, the modulated HARQ-ACK symbols may be mapped starting on the first available non-DMRS symbol after the first DMRS symbol irrespective of a quantity (e.g., number) of DMRS symbols allocated in the PUSCH transmission. Additionally, or alternatively, the network may configure the UE 215-b to map a first portion of the CSI and a second portion of the CSI starting on the first available non-DMRS symbol (e.g., irrespective of the quantity of DMRS symbols allocated in the PUSCH transmission). In some examples, if the PUSCH transmission is punctured by feedback information (e.g., HARQ-ACK), the network may configure the UE 215-b to map the first portion of the CSI starting after a particular amount of reserved HARQ-ACK resource elements. That is, the first portion of the CSI may not be mapped on the reserved HARQ-ACK resource elements.

Additionally, or alternatively, the second portion of the CSI may not be mapped on the resource elements for the first portion of the CSI. In some examples, the second portion of the CSI and the PUSCH data may be mapped to reserved HARQ-ACK resource elements, if the PUSCH is rate matched by the HARQ-ACK. Additionally, or alternatively, the network may configure the UE 215-b to map HARQ-ACK and then (e.g., subsequently) map the first portion of the CSI report. In such an example, the first portion of the CSI report and the second portion of the CSI report may not be mapped on the HARQ-ACK resource elements.

In some examples, for uplink control information on the PUSCH with uplink shared channel data, the quantity of resources used for the first portion of the CSI (e.g., CSI part 1) may be calculated according to the following Equation 1:

$$\begin{matrix}{{Q}^{′}}_{C S I - 1} = m i n \left\{\left[\frac{\left({O}_{C S I - 1} + {L}_{C S I - 1}\right) {β}_{o f f s e t}^{P U S C H} ⋅ {\sum }_{l = 0}^{{N}_{s y m b , a l l}^{P U S C H} - 1} {M}_{S C}^{U C I} \left(l\right)}{{\sum }_{r = 0}^{{C}_{U L - S C H} - 1} {K}_{r}}\right] ,\right) \\ \left(\left[α ⋅ {\sum }_{l = 0}^{{N}_{s y m b , a l l}^{P U S C H} - 1} {M}_{S C}^{U C I} \left(l\right)\right] - {{Q}^{′}}_{A C K}\right\} .\end{matrix} \qquad \text{(1)}$$

where the parameter Q′_{CSI-1} may represent a quantity of coded modulation symbols (e.g., per layer) for transmission of the first portion of a CSI report, the parameter 0_{CSI-1} may represent a quantity of bits corresponding to the first portion of a CSI report, and the parameter L_{CSI-1} may represent a quantity of cyclic redundancy check bits for the first portion of the CSI report. In some examples, the parameter

$${β}_{o f f s e t}^{P U S C H}$$

^{PUSCH} may offset represent an offset (e.g., scaling factor), the parameter

$${M}_{S C}^{U C I}$$

(l) may represent a quantityof resource elements that may be used for transmission of uplink control information in an OFDM symbol (l) in the PUSCH transmission, the parameter

$${N}_{s y m b , a l l}^{P U S C H}$$

may represent a quantity (e.g., a total number) of OFDM symbols of the PUSCH (e.g., including OFDM symbols allocated for DMRSs), and the parameter α may represent a scaling factor (e.g., configured via higher layer signaling). In some examples, the parameter C_{UL-SCH} may represent a quantity of code blocks for the uplink shared channel data of the PUSCH transmission and the parameter Kᵣ may represent a (e.g., the rth) code block size for the uplink shared channel data of the PUSCH transmission. Additionally, or alternatively, the parameter Q′_{ACK} may represent a quantity of coded modulation symbols (e.g., per layer) for feedback information (e.g., HARQ-ACK) transmitted the PUSCH.

Additionally, or alternatively, for uplink control information on the PUSCH without an uplink shared channel data, the quantity of resources used for the first portion of the CSI (e.g., the CSI part 1) may be calculated according to the following Equation 2:

$$\begin{matrix}{{Q}^{′}}_{C S I - 1} = \\ m i n \left\{\left[\frac{\left({O}_{C S I - 1} + {L}_{C S I - 1}\right) {β}_{o f f s e t}^{P U S C H} \text{} ⋅}{R ⋅ {Q}_{m}}\right] , {\sum }_{l = 0}^{{N}_{s y m b , a l l}^{P U S C H} - 1} {M}_{S C}^{U C I} \left(l\right) - {{Q}^{′}}_{A C K}\right\} .\end{matrix} \qquad \text{(2)}$$

where the parameter R may represent a coding rate of the PUSCH and the parameter Qₘ may represent a modulation order of the PUSCH.

Additionally, or alternatively, for uplink control information on the PUSCH with uplink shared channel data, the quantity of resources used for a second portion of the CSI (e.g., CSI part 2) may be calculated according to the following Equation 3:

$$\begin{matrix}{{Q}^{′}}_{C S I - 2} = m i n \left\{\left[\frac{\left({O}_{C S I - 2} + {L}_{C S I - 2}\right) {β}_{o f f s e t}^{P U S C H} ⋅ {\sum }_{l = 0}^{{N}_{s y m b , a l l}^{P U S C H} - 1} {M}_{S C}^{U C I} \left(l\right)}{{\sum }_{r = 0}^{{C}_{U L - S C H} - 1} {K}_{r}}\right] ,\right) \\ \left(\left[α ⋅ {\sum }_{l = 0}^{{N}_{s y m b , a l l}^{P U S C H} - 1} {M}_{S C}^{U C I} \left(l\right)\right] - {{Q}^{′}}_{A C K} - {{Q}^{′}}_{C S I - 1}\right\} .\end{matrix} \qquad \text{(3)}$$

where the parameter Q′_{CSI-2} may represent a quantity of coded modulation symbols (e.g., per layer) for transmission of a second portion of a CSI report, the parameter O_{CSI-2} may represent a quantity of bits corresponding to the second portion of a CSI report, and the parameter L_{CSI-2} may represent a quantity of cyclic redundancy check bits for the second portion of the CSI report.

$${\text{Σ}}_{l = 0}^{{N}_{s y m b , a l l}^{P U S C H} - 1}$$

$${M}_{S C}^{U C I}$$

In some examples, the term

$${\text{Σ}}_{l = 0}^{{N}_{s y m b , a l l}^{P U S C H} - 1}$$

$${M}_{S C}^{U C I} \left(l\right)$$

may corresponds to a quantity of resources available for uplink control information, and the term

$${\text{Σ}}_{r = 0}^{{C}_{U L - S C H} -}$$

Kᵣ may corresponds to a quantity of bits in a coding block. Therefore, the coding rate of the PUSCH transmission may be determined according to the following Equation 4:

$$\frac{{\sum }_{l = 0}^{{N}_{s y m b , a l l}^{P U S C H} - 1} {M}_{S C}^{U C I} \left(l\right)}{{\sum }_{r = 0}^{{C}_{U L - S C H} - 1} {K}_{r}} = \frac{1}{c o d i n g r a t e} . \qquad \text{(4)}$$

Additionally, or alternatively, for uplink control information on the PUSCH without uplink shared channel data, the quantity of resources used for the second portion of the CSI (e.g., the CSI part 2) may be calculated according to the following Equation 5:

$${{Q}^{′}}_{C S I - 2} = {\sum }_{l = 0}^{{N}_{s y m b , a l l}^{P U S C H} - 1} {M}_{S C}^{U C I} \left(l\right) - {{Q}^{′}}_{A C K} - {{Q}^{′}}_{C S I - 1} . \qquad \text{(5)}$$

In some other examples, the network may configure the UE 215-b with one or more rules for mapping uplink control information on a PUCCH. For example, the network may configure the UE 215-b according to a PUCCH format (e.g., PUCCH format 2). In such an example, the network may configure the UE 215-b to encode (e.g., jointly encode) one or more bits corresponding to feedback information (e.g., HARQ-ACK), a scheduling request, the CSI report, or any combination thereof. Additionally, or alternatively, a quantity of CSI bits (e.g., corresponding to the CSI report) that may be appended to the feedback information bits or the scheduling request bits may be determined, such that the uplink control information bits appended by the cyclic redundancy check may be encoded with a coding rate that may not exceed a threshold (e.g., a maximum configured coding rate or an otherwise suitable coding rate). In some examples, if the coding rate exceeds the threshold for the PUCCH Format 2, the UE 215-b may drop the CSI bits, for example using a same priority rule (or rules) as may be used for CSI omission on the PUSCH.

In some other examples, the network may configure the UE 215-b according to one or more other PUCCH formats (e.g., PUCCH format 3, PUCCH format 4). In such examples, simultaneous transmission of the feedback information, the scheduling request, and the CSI report may be configured via control signaling. For example, the network may use a configuration (e.g., an RRC configuration) to configure the UE 215-b to encode (e.g., jointly encode) the feedback information (e.g., with or without a scheduling request) and a first portion of the CSI report. In such an example, a second portion of the CSI may be subsequently encoded (e.g., separately encoded). Additionally, or alternatively, the network may configure the UE 215-b to encode (e.g., jointly) the feedback information (e.g., with or without the scheduling request) and the first portion of the CSI report with a coding rate (e.g., a maximum coding rate or an otherwise suitable coding rate for the PUCCH Format 3 or the PUCCH Format 4). In some examples, remaining resources (e.g., if available) of the configured resources (e.g., physical resource blocks (PRB)) may be used for encoding the second portion of the CSI report. In some examples, some (or all) of the bits of the second portion of the CSI report may be dropped, for example using a same priority rule (or rules) as may be used for omitting CSI on the PUSCH.

In some examples, however, configure the UE 215-b to measure and report CLI via lower-layer signaling (e.g., as part of the CSI framework) may increase control signaling overhead (e.g., associated with transmitting the channel sate information report) at the UE 215-b. Therefore, in some other examples of CLI reporting via lower-layer signaling, the network may configure the UE 215-b to measure and report CLI via a dedicated CLI reporting framework. In such an example, the CLI report configuration may include CLI measurement resource (e.g., resources for zero power SRS or CSI interference measurement) that may be based on CLI measurement resources. In some examples, by using the dedicated CLI reporting framework, the network may reduce the impact of CLI reporting on CSI processes. For example, CLI reporting may be configured as a type of uplink control information (e.g., in addition to uplink control information for CSI reporting or other information).

In such cases, if the network configures the UE 215-b to measure and report the CLI report via the dedicated CLI reporting framework, the CLI reporting may be configured separately from the CSI reporting. For example, the CLI reporting may be configured for the UE 215-b as part of another type of uplink control information (e.g., in addition to CSI, the feedback information, and scheduling resources). Accordingly, the network may configure the UE 215-b with one or more rules for performing CLI measurement and reporting. For example, the network may configure the UE 215-b with (e.g., define) one or more rules for multiplexing CLI on one or more physical uplink channels (e.g., the PUSCH, the PUCCH, or both). Additionally, or alternatively, the network may configure the UE 215-b with one or more rules for determining a quantity of resources to be used for multiplexing the CLI on a physical uplink channel (e.g., the PUSCH). For example, the network may configure the UE 215-b with one or more offset values, such as the parameter

$${β}_{o f f s e t}^{P U S C H}$$

, to be used for determining the quantity of resources. Additionally, or alternatively, the network may configure the UE 215-b with one or more rules for mapping the CLI report on the PUSCH (e.g., one or more mapping rules for PUSCH allocation). In some examples, the network may configure the UE 215-b with one or more rules for determining whether the CLI report may be multiplexed on the PUCCH. In such an example, the network may configure the UE 215-b with one or more rules for encoding (e.g., and mapping) the CLI report to the PUCCH.

In some examples, the network may configure the UE 215-b with such rules via a CLI report configuration (e.g., via a CLIreportconfig IE). For example, the UE 215-b may receive a first message indicating a CLI report configuration 255. In some examples, the CLI report configuration 255 may be associated with a first set of rules for determining a quantity of resources for multiplexing a CLI report 260 on a physical uplink channel and a second set of rules for multiplexing the CLI report 260 on the physical uplink channel over the quantity of resources. In some examples, the UE 215-b may transmit the CLI report 260 on the physical uplink channel in accordance with the first set of rules and the second set of rules. The CLI report 260 may indicate one or more CLI measurements performed by the UE.

Techniques for CLI reporting on physical uplink channels, as described herein, may provide one or more enhancements to network performance in some network deployment scenarios. In some examples, such techniques for CLI reporting on physical uplink channels may provide one or more enhancements for interference mitigation (e.g., interference handling, interference management), such as inter-network entity CLI, inter-UE CLI, self-interference, inter-sub-band CLI, and inter-operator CLI. For example, by transmitting the CLI report 260 to the network, the UE 215-b may provide one or more enhancements to CLI mitigation techniques performed by the network, among other benefits.

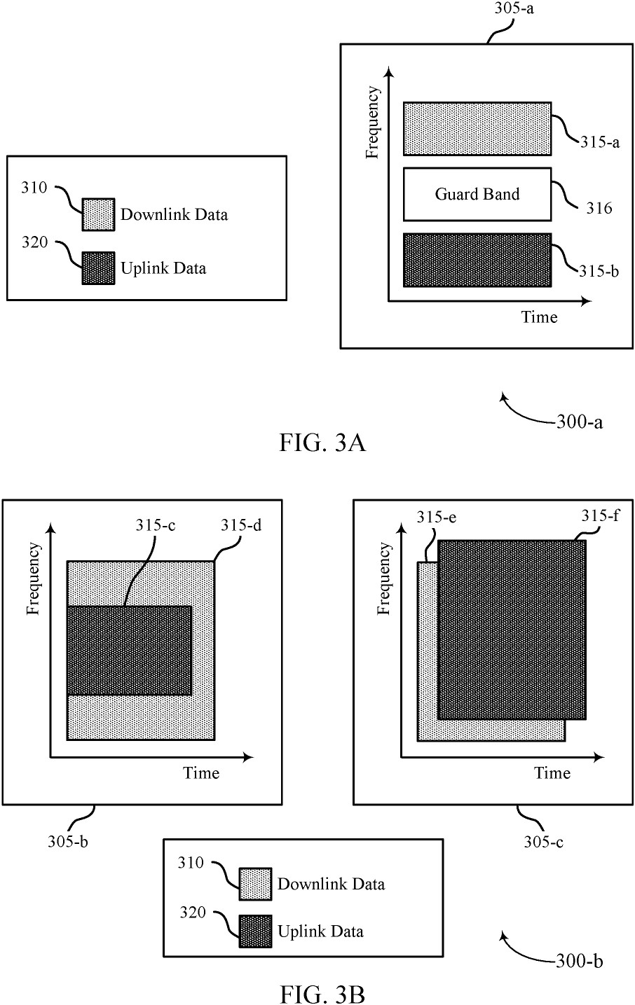

FIGS. 3A and 3B each illustrate an example of a full-duplex operation scheme 300 that supports CLI reporting on physical uplink channels in accordance with one or more aspects of the present disclosure. In some examples, the full-duplex operation schemes 300 (a full-duplex operation scheme 300-a and a full-duplex operation scheme 300-b) may implement or be implemented by aspects of the wireless communications system 100. For example, the full-duplex operation schemes 300 may each be implemented by a network entity or a UE, which may be examples of the corresponding devices as described with reference to FIG. 1. In some examples of FIGS. 3A and 3B, the network entity may be an example of a CU 160, a DU 165, an RU 170, a base station 140, an IAB node 104, or one or more other network nodes as described with reference to FIG. 1. The full-duplex operation schemes 300 may include features for improved communications between the UE and the network, among other benefits.

In some examples, a wireless communications device (e.g., the network entity or the UE) may support full-duplex communications, in which the communication device may transmit and receive communication simultaneously, thereby promoting latency savings enabled by receiving downlink signal in uplink slots (or symbols). In some examples, the communication device may support multiple (e.g., two) types of full-duplex operations. For example, the communication device may support SBFD operations, in which the communication device may transmit and receive communications over a same time resource and on different frequency resources. That is, the downlink resources may be separated from the uplink resource in the frequency domain.

For example, as illustrated by the example of FIG. 3A, the network may configure one or more UEs in accordance with the configuration 305-a. In such an example, the network may configure downlink transmissions (e.g., transmissions of downlink data 310) for the UE in frequency domain resources (e.g., a resource 315-a) that may be adjacent to frequency domain resources (e.g., a resource 315-b) configured for uplink transmission (e.g., transmissions of uplink data 320) of another UE. In some examples, to reduce interference between the uplink transmissions (e.g., scheduled for the resource 315-a) and the downlink transmissions (e.g., scheduled for the resource 315-b), the network may configure the resource 315-a and the resource 315-b to be separated by a guard band 316.

Additionally, or alternatively, as illustrated in the example of FIG. 3B, the network (e.g., the network entity) may support IBFD operations, such that the network entity may transmit and receive communications on a same time resource and a same frequency resource (e.g., a same slot and carrier bandwidth). For example, the network may configure one or more UEs in accordance with the configuration 305-b, the configuration 305-c, or both. In such an example, the network may configure downlink transmissions (e.g., transmission of the downlink data 310) and the uplink transmissions (e.g., transmission of the uplink data 320), such that the downlink transmission and the uplink transmissions may share a same one or more time and frequency resources (e.g., IBFD time and frequency resources). In some examples, the network may configure one or more UEs in accordance with the configuration 305-b, such that one or more time and frequency resources allocated for transmission of the uplink data 320 (e.g., a resource 315-c) may overlap (e.g., fully overlap) with one or more time and frequency resources allocated for transmission of the downlink data 310 (e.g., a resource 315-d). Additionally, or alternatively, the network may configure one or more UEs in accordance with the configuration 305-c, such that a portion of the one or more time and frequency resources allocated for transmission of the uplink data 320 (e.g., a resource 315-e) may overlap with a portion of the one or more time and frequency resources allocated for transmission of the downlink data 310 (e.g., a resource 315-f). That is, the resource 315-e) may partially overlap with the resource 315-f.

In some examples, while full-duplex communications may provide for one or more spectrum efficiency enhancements (e.g., per cell or per UE), efficient resource utilization, and coverage area extension, concurrent full-duplex communications performed by neighboring communication devices may lead to CLI. For example, neighboring communication devices may perform full-duplex communications concurrently, such that communications received by a first communication device may overlap in time with communications transmitted by a second communication device (e.g., a neighboring communication device). In such an example, the communications transmitted by the second communication device may lead to CLI at the first communication device. In some examples, to reduce the effects of CLI, the network may employ one or more interference mitigation techniques.

Some techniques for CLI reporting on physical uplink channels, as described herein, may provide one or more enhancements to interference mitigation techniques. For example, the network may transmit a first message indicating a CLI report configuration to a UE. In some examples, the CLI report configuration may be associated with a first set of rules for determining a quantity of resources for multiplexing a CLI report on a physical uplink channel and a second set of rules for multiplexing the CLI report on the physical uplink channel over the quantity of resources. In some examples, the network may receive the CLI report on the physical uplink channel in accordance with the first set of rules and the second set of rules. The CLI report may indicate one or more CLI measurements performed by the UE. In some examples, the network may apply one or more CLI mitigation techniques based on the CLI report. For example, the network may schedule the UEs such that CLI may be reduced. Additionally, or alternatively, the network entity may indicate for one or more of the UEs to switch beams such that CLI may be reduced. Therefore, by receiving the CLI report, the network may provide one or more enhancements to CLI mitigation techniques performed by the network, among other benefits.

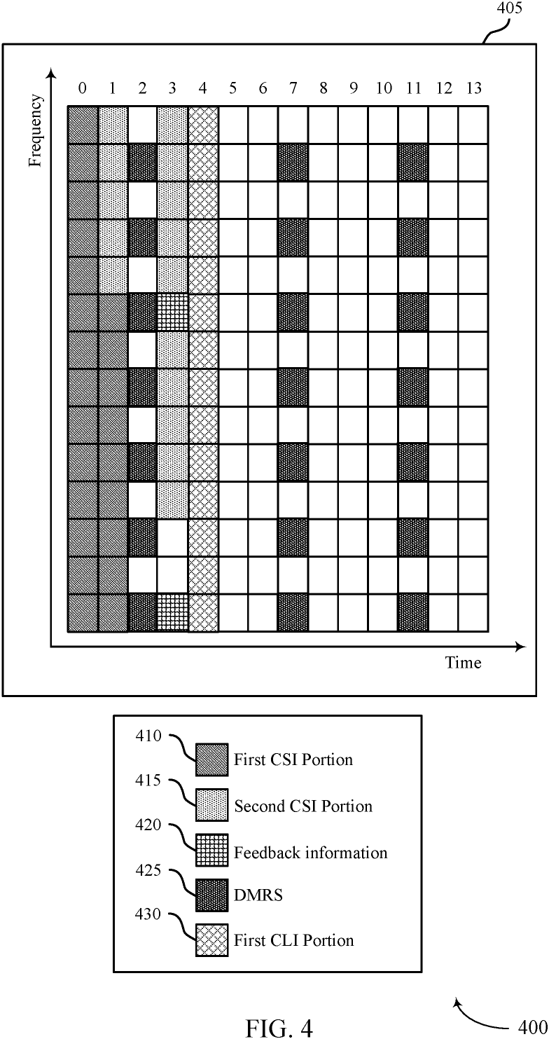

FIG. 4 illustrates an example of a resource mapping 400 that supports CLI reporting on physical uplink channels in accordance with one or more aspects of the present disclosure. In some examples, the resource mapping 400 may implement or be implemented by aspects of the wireless communications system 100. For example, the resource mapping 400 may be implemented by a network entity or a UE, which may be examples of the corresponding devices as described with reference to FIG. 1. In the example of FIG. 4, the network entity may be an example of a CU 160, a DU 165, an RU 170, a base station 140, an IAB node 104, or one or more other network nodes as described with reference to FIG. 1. The resource mapping 400 may include features for improved communications between the UE and the network, among other benefits.

In some examples, the network may configure one or more communication devices (e.g., the UE) to measure and report the CLI report via a dedicated CLI reporting framework. In such examples, the network may configure the UE with one or more rules for performing the CLI measurement and reporting. For example, the network may configure the UE with one or more rules for multiplexing CLI on one or more physical uplink channels (e.g., a PUSCH, a PUCCH, or both). As illustrated in the example of FIG. 4, the network may configure a CLI report to be multiplexed on the PUSCH. In such an example, the network may configure the UE with one or more rules for multiplexing (e.g., and mapping) the CLI report on the PUSCH (e.g., one or more mapping rules for PUSCH allocation). In some examples, the network may configure the UE to multiplex (e.g., transmit) a CLI report on the PUSCH and refrain from multiplexing (e.g., transmitting) a CSI report on the PUSCH. In such an example, the network may configure the UE to map a CLI report to resource of the PUSCH in accordance with a same mapping that may be used by the UE for mapping a CSI report on the PUSCH.

Additionally, or alternatively, the UE may be configured to multiplex a CSI report and a CLI report on the PUSCH. In such an example, the network may configure the UE to multiplex the CLI report subsequent to the CSI report. That is, the CSI report may be assigned an increased priority relative to the CLI report. For example, the network may configure the UE to map a first portion of the CSI report and a second portion of the CSI report to resource elements on the PUSCH prior to mapping a first portion of the CLI report and a second portion of the CLI report (e.g., if available). As illustrated in the example of FIG. 4, the network may configure the UE to map a first CSI portion 410 and a second CSI portion 415 to resource elements on a PUSCH 405 prior to mapping a first CLI portion 430.

Additionally, or alternatively, the network may configure the UE to multiplex the first portion of the CLI report and the first portion of the CSI report prior to the second portion of the CSI report. That is, the CLI report may be assigned an increased priority relative to the second portion of the CSI report. For example, the network may configure the UE to map a first portion of the CSI report and a first portion of the CLI report to resource elements on the PUSCH prior to mapping a second portion of the CSI report and a second portion of the CLI report (e.g., if available). As illustrated in the example of FIG. 4, the network may configure the UE to map the first CSI portion 410 and the first CLI portion 430 to resource elements on the PUSCH 405 prior to mapping the second CSI portion 415.

Additionally, or alternatively, the network may configure the UE with one or more rules for determining resources to be used for multiplexing the CLI on a physical uplink channel (e.g., the PUSCH). For example, based on the one or more rules for multiplexing CLI on the PUSCH, the UE may determine a quantity of resource elements allocated for each of multiple types of uplink control information (e.g., the first CSI portion 410, the second CSI portion 415, feedback information 420, DMRS 425, and the first CLI portion 430 according to one or multiple rules). For example, if the CLI report is assigned an increased priority relative to the second portion of the CSI report (e.g., if the first CLI portion 430 is mapped prior to the second CSI portion 415) the UE may determine the quantity of resource elements allocated for each of multiple types of uplink control information according to Equation 6 or Equation 7 (or both).

In some examples, for uplink control information on the PUSCH with uplink shared channel data, the quantity of resources used for the second CSI portion 415 (e.g., CSI part 2) may be calculated according to the following Equation 6:

$$\begin{matrix}{{Q}^{′}}_{C S I - 2} = m i n \left\{\left[\frac{\left({O}_{C S I - 2} + {L}_{C S I - 2}\right) {β}_{o f f s e t}^{P U S C H} ⋅ {\sum }_{l = 0}^{{N}_{s y m b , a l l}^{P U S C H} - 1} {M}_{S C}^{U C I} \left(l\right)}{{\sum }_{r = 0}^{{C}_{U L - S C H} - 1} {K}_{r}}\right] ,\right) \\ \left(\left[α ⋅ {\sum }_{l = 0}^{{N}_{s y m b , a l l}^{P U S C H} - 1} {M}_{S C}^{U C I} \left(l\right)\right] - {{Q}^{′}}_{A C K} - {{Q}^{′}}_{C S I - 1} - {{Q}^{′}}_{C L I - 1}\right\} .\end{matrix} \qquad \text{(6)}$$

where the parameter Q′_{CLI-1} may represent a quantity of coded modulation symbols (e.g., per layer) for transmission of the first CLI portion 430 (e.g., CLI part 1).

Additionally, or alternatively, for uplink control information on the PUSCH without uplink shared channel data, the quantity of resources used for the second CSI portion 415 may be calculated according to the following Equation 7:

$${{Q}^{′}}_{C S I - 2} = {\sum }_{l = 0}^{{N}_{s y m b , a l l}^{P U S C H} - 1} {M}_{S C}^{U C I} \left(l\right) - {{Q}^{′}}_{A C K} - {{Q}^{′}}_{C S I - 1} - {{Q}^{′}}_{C L I - 1} . \qquad \text{(7)}$$

In some examples, the network may configure the UE with one or more of the offset values (e.g., cross-link information offset values,

$${β}_{o f f s e t}^{P U S C H}$$

) to be used for determining the quantity of resources dedicated for transmission of a CLI report on the PUSCH (e.g., according to Equation 6 or Equation 7). The cross-link information offset values may be examples of the offset values as described with reference to FIG. 2. In some examples, the cross-link information offset values may be indicated via parameters (e.g., one or more offset indicators), such as a beta_cli_pl IE and a beta cli_p2 IE, that may be different from parameters (e.g., a beta_csi_pl IE and a beta csi_p2 IE) used to indicate offset values for CSI (e.g., CSI offset values). In some examples, the CLI offset values (e.g., indicated via the beta cli_pl IE and the beta cli_p2 IE) may be semi-statically configured or dynamically indicated. In some examples, CLI offset values that are semi-statically configured (e.g., via RRC signaling) may be different from offset values semi-statically configured for CSI (e.g., semi-statically configured CSI offset values).

In some examples, for dynamic indication of the CLI offset values, the network may trigger the UE to perform crosslink interference reporting via a dedicated DCI. In such an example, the CLI offset values may be indicated to the UE via same signaling (e.g., reuse 2 bits of a same DCI) as may be used to indicate offset values for CSI reporting (e.g., CSI offset values). Additionally, or alternatively, the network may trigger the UE to perform both crosslink interference reporting and CSI reporting via a dedicated DCI (e.g., a same dedicated DCI). In such an example, the CLI offset values and the CSI offset values may be indicated to the UE via same signaling. That is, a same DCI message (e.g., 2 bits of a same DCI) may be used to indicate offset values for both CLI reporting and CSI reporting. In such an example, the network may configure the UE with a table that may enable selection (e.g., joint selection) of offset values for CLI reporting and CSI reporting. Additionally, or alternatively, the network may configure the UE with CLI offset values via relative offsets from channel state interference offset values (e.g., indicated via the dedicated DCI). That is, the relative offsets may be configurable by the network (e.g., via an RRC configuration for CLI reporting). In some examples, the network may semi-statically configure the UE to determine CLI offset values using a difference from CSI offset values, in which the difference may be indicated to the UE via semi-static signaling and the CSI offsets may be indicated to the UE via dynamic signaling (e.g., the beta csi_pl IE and the beta csi_p2 IE).

In some examples of dynamic indication of the CLI offset values, the network may trigger the UE to perform crosslink interference reporting via a DCI that may be common to multiple UEs (e.g., a group-common DCI). In such an example, the network may configure the network may configure PUSCH resources (e.g., for carrying the CLI report) via semi-static signaling (e.g., via RRC). In such an example, the network may indicate the CLI offset values via parameters included in a configuration, such as via the beta cli_pl IE and the beta cli_p2 IE of an RRC configuration. Additionally, or alternatively, the network may configure the UE to multiplex the CLI report on another PUSCH, such as a dynamic PUSCH. In such an example, the network may configure the UE to use (e.g., follow) CLI offset values indicated to the network via a DCI (e.g., if available). In some examples, if the UE fails to receive (or the network refrains from transmitting) a DCI including the CLI offset values, the UE may use CLI offset values indicated to the UE via control signaling, such as RRC signaling (e.g., the UE may follow RRC configured CLI offset values).

Additionally, or alternatively, the network may configure the UE with one or more rules for determining whether the CLI report may be multiplexed on the PUCCH. In such an example, the network may configure the UE with one or more rules for encoding (e.g., and mapping) the CLI to the PUCCH. In some examples, the network may configure the UE to multiplex (e.g., transmit) a CLI report on the PUCCH and refrain from multiplexing a CSI report on the PUCCH. In such an example, the network may configure the UE to multiplex the CLI report to resource of the PUSCH in accordance with a same one or more rules that may be used by the UE for multiplexing the CSI report to the PUCCH.

The UE may be configured to multiplex a CSI report and a CLI report on the PUCCH. In such an example, the network may configure the UE to multiplex the CLI report on the PUCCH based on values of one or more parameters (e.g., a simultaneousHARQ-ACK-CLI IE and a simultaneousCSI-CLI IE) indicated to the UE from the network. For example, the UE may determine whether to multiplex downlink feedback information (e.g., downlink HARQ-ACK), with or without a scheduling request, and the CLI report in a same PUCCH based on the value of a first parameter, such as the simultaneousHARQ-ACK-CLI IE. In some examples, if the UE fails to receive (e.g., or the network refrains from transmitting) the first parameter, the UE may drop the CLI report and includes the downlink feedback information (e.g., with or without the scheduling request) in the PUCCH. Additionally, or alternatively, the UE may determine whether to multiplex a CSI report and the CLI report in a same PUCCH based on a value of a second parameter, such as the simultaneousCSI-CLI IE. In some examples, if the UE fails to receive (e.g., or the network refrains from transmitting) the second parameter, the UE may drop the CLI report and include the CSI report in the PUCCH.

In some examples, information corresponding to the one or more parameters (e.g., flags) may not be available to the UE. In such examples, the UE may refrain from following (e.g., may ignore) one or more flags. For example, if a CLI report is available to the UE and a CSI report is not available to the UE, the UE may multiplex the CLI report irrespective of the value of the second parameter (e.g., the value of the simultaneousCSI- CLI IE).

In some examples, if a CLI report or a CSI report is available to the UE (e.g., if the UE is configured to report CLI or CSI), the UE may determine whether multiplex the CLI report or the CSI report on a same PUCCH as downlink feedback information based on the value of one or more respective parameters. For example, if the UE is configured to report CLI, the network may configure the UE to determine whether to multiplex the CLI report on a same PUCCH (e.g., as the downlink feedback information) based on a value of a first parameter, such as the simultaneousHARQ-ACK-CLI IE. In some examples, the UE may multiplex the downlink feedback (e.g., with or without the scheduling request) and refrain from multiplexing the CLI report if the value of the first parameter (e.g., the simultaneousHARQ-ACK-CLI IE) is set to zero. Accordingly, the UE may determine to multiplex the downlink feedback (e.g., with or without the scheduling request) and the CLI report if the value of the first parameter (e.g., the simultaneousHARQ-ACK-CLI IE) is set to one.

Additionally, or alternatively, if the UE is configured to report CSI, the network may configure the UE to determine whether to multiplex the CSI on a same PUCCH (e.g., as the downlink feedback information) based on a value of a second parameter (e.g., a simultaneousHARQ-ACK-CSI IE). In some examples, the UE may multiplex the downlink feedback (e.g., with or without the scheduling request) and refrain from multiplexing the CSI report if the value of the second parameter (e.g., the simultaneousHARQ-ACK-CSI IE) is set to zero. Accordingly, the UE may determine to multiplex the downlink feedback (e.g., with or without the scheduling request) and the CSI report if the value of the second parameter (e.g., the simultaneousHARQ-ACK-CSI IE) is set to one.

In some examples, if a CLI report and a CSI report is available to the UE (e.g., if the UE is configured to report CLI and CSI), the UE may determine whether to multiplex the CLI report and the CSI report on a same PUCCH based on the value of a third parameter, such as a simultaneousCSI-CLI IE. For example, the UE may multiplex the downlink feedback (e.g., with or without the scheduling request), the CLI report, and the CSI report if the value of the third parameter (e.g., the simultaneousCSI-CLI IE) is set to one. Additionally, or alternatively, the UE may multiplex the downlink feedback (e.g., with or without the scheduling request) and the CSI report and refrain from multiplexing the CLI report if the value of the third parameter (e.g., the simultaneousCSI-CLI IE) is set to zero.

In some examples, if the network configures the UE to report CLI and CSI on the PUCCH, the UE may multiplex the CLI report and the CSI report according to one or more rules (e.g., configured by the network). In some examples, the one or more rules for multiplexing the CLI report and the CSI report may depend on the format of the PUCCH. For PUCCH-format2, the network may configure the UE to multiplex the CSI report on the PUCCH and drop the CLI report.

In some examples, the network may configure the UE according to a PUCCH format (e.g., a PUCCH format 3 or a PUCCH format 4). In such an example, the network may configure the UE with one or more rules for simultaneous transmission of downlink feedback (e.g., with our without the scheduling request), a CSI report, and a CLI report via control signaling (e.g., via an RRC configuration). For example, the network may configure the UE to multiplex the downlink feedback information (e.g., with our without the scheduling request) and a first portion of the CSI report prior to multiplexing the CLI report. That is, the network may configure the UE to jointly encode bits corresponding to the downlink feedback information (e.g., with our without the scheduling request) and bits corresponding to the first portion of the CSI report and may separately encode bits corresponding to a first portion of the CLI report, bits corresponding to a second portion of the CSI report, and bits corresponding to a second portion of the CLI report (e.g., if configured). In such an example, the feedback information (e.g., with or without the scheduling request) and the first portion of the CSI report may be jointly encoded with a configured coding rate (e.g., a maximum coding rate or an otherwise acceptable coding rate of the PUCCH format 3 or of the PUCCH format 4). Additionally, or alternatively, remaining resources in the configured PRB (e.g., if available) may be used for encoding of the first portion of the CLI report, the second portion of the CSI report, and the second portion of the CLI report (e.g., if configured).

In some examples, the UE may encode the first portion of the CLI report, the second portion of the CSI report, and the second portion of the CLI report (e.g., if configured) based on a respective priority of the CLI report and the CSI report. For example, some (or all) of the bits corresponding to the first portion of the CLI report, the second portion of the CSI report, and the second portion of the CLI may be dropped (e.g., due to a lack of remaining resources) according to an ordering that may be based on the respective priority of the CLI report and the CSI report. In some examples, the order in which bits are dropped may start from bits associated with a relatively lowest priority. In some examples, the order (e.g., the priority order from relatively high priority to relatively low priority) may indicate for the UE to encode the first portion of the CLI report, the second portion of the CSI report, and then the second portion of the CLI.

Additionally, or alternatively, the ordering may indicate for the UE to encode the second portion of the CSI report, the first portion of the CLI report, and then the second portion of the CLI. In some cases, the network may configure the UE to jointly encode bits corresponding to the feedback information (e.g., with or without the scheduling request), the first portion of the CSI report, and the first portion of the CLI report. In some examples (e.g., if configured), the UE may separately encode bits corresponding to the second portion of the CSI report and the second portion of the CLI report. In such an example, some (or all) of the bits corresponding to the second portion of the CSI report and the second portion of the CLI report may be dropped based on a respective priority of the CSI report and the CLI report (e.g., may be dropped starting with the bits corresponding to the second portion of the CLI report).

In some examples, the network may configure the UE with one or more rules for performing the CLI measurement and reporting via a CLI report configuration (e.g., via a CLIreportconfig IE). For example, the UE may receive a first message indicating a CLI report configuration. In some examples, the CLI report configuration may be associated with a first set of rules for determining a quantity of resources for multiplexing a CLI report on a physical uplink channel and a second set of rules for multiplexing the CLI report on the physical uplink channel over the quantity of resources. In some examples, the UE may transmit the CLI report on the physical uplink channel in accordance with the first set of rules and the second set of rules. The CLI report may indicate one or more CLI measurements performed by the UE. In some examples, by transmitting the CLI report to the network, the UE may provide one or more enhancements to CLI mitigation techniques performed by the network, among other benefits.

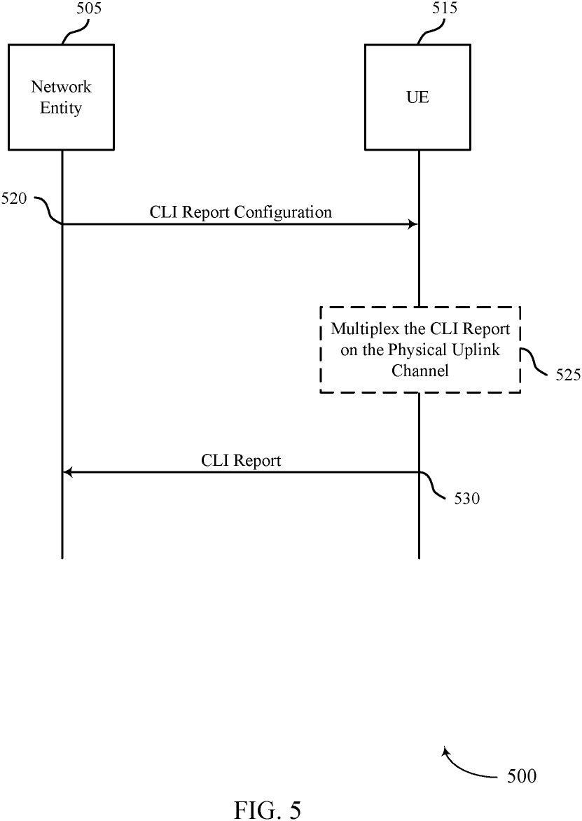

FIG. 5 illustrates an example of a process flow 500 in a system that supports CLI reporting on physical uplink channels in accordance with one or more aspects of the present disclosure. The process flow 500 may implement or be implemented by one or more aspects of the wireless communications system 100 and the wireless communications systems 200. For example, the process flow 500 may include a network entity 505 and a UE 515, which may be examples of the corresponding devices as described with reference to FIGS. 1, 2A, 2B, and 2C. The process flow 500 may be implemented by the network entity 505, the UE 515, or both. In the following description of the process flow 500, operations between the network entity 505 and the UE 515 may occur in a different order or at different times than as shown. Some operations may also be omitted from the process flow 500, and other operations may be added to the process flow 500.

At 520, the UE 515 may receive a first message indicating a CLI report configuration. The CLI report configuration may be an example of a CLI report configuration as described with reference to FIGS. 2A, 3, and 4. For example, the CLI report configuration may be associated with a first set of rules for determining a quantity of resources for multiplexing a CLI report on a physical uplink channel and a second set of rules for multiplexing the CLI report on the physical uplink channel over the quantity of resources.

In some examples, at 525, the UE 515 may multiplex the CLI report on the physical uplink channel. For example, the UE 515 may multiplex the CLI report on the physical uplink channel (e.g., PUSCH, PUCCH) over the quantity of resources based on the second set of rules.

At 530, the UE 515 may transmit the CLI report on the physical uplink channel in accordance with the first set of rules and the second set of rules. For example, the UE 515 may transmit the CLI report based on multiplexing the CLI report on the physical uplink channel at 525. In some examples, the CLI report may be an example of a CLI report as described with reference to FIGS. 2A, 3, and 4. For example, the CLI report may indicate one or more CLI measurements performed by the UE 515.

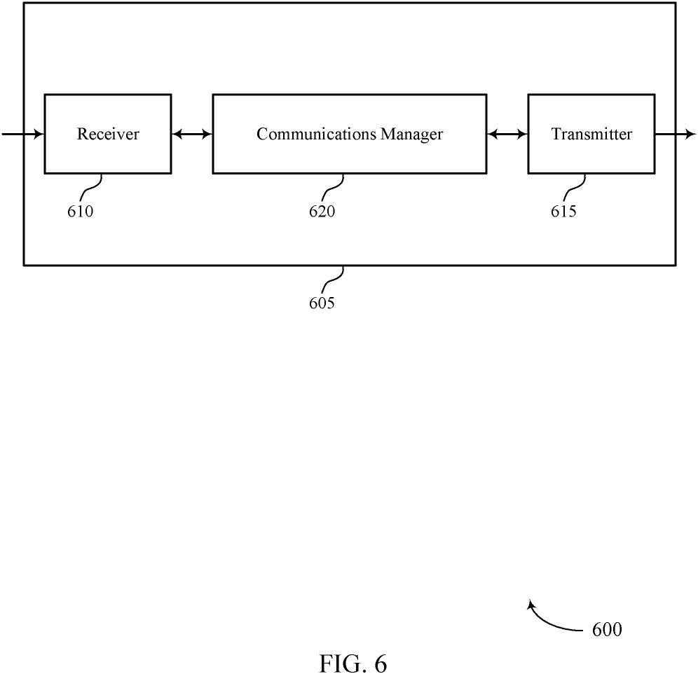

FIG. 6 shows a block diagram 600 of a device 605 that supports CLI reporting on physical uplink channels in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to CLI reporting on physical uplink channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CLI reporting on physical uplink channels). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of CLI reporting on physical uplink channels as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. For example, the communications manager 620 may be configured as or otherwise support a means for receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The communications manager 620 may be configured as or otherwise support a means for transmitting the CLI report on the physical uplink channel in accordance with the first set of rules and the second set of rules, the CLI report indicating one or more CLI measurements performed by the UE.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

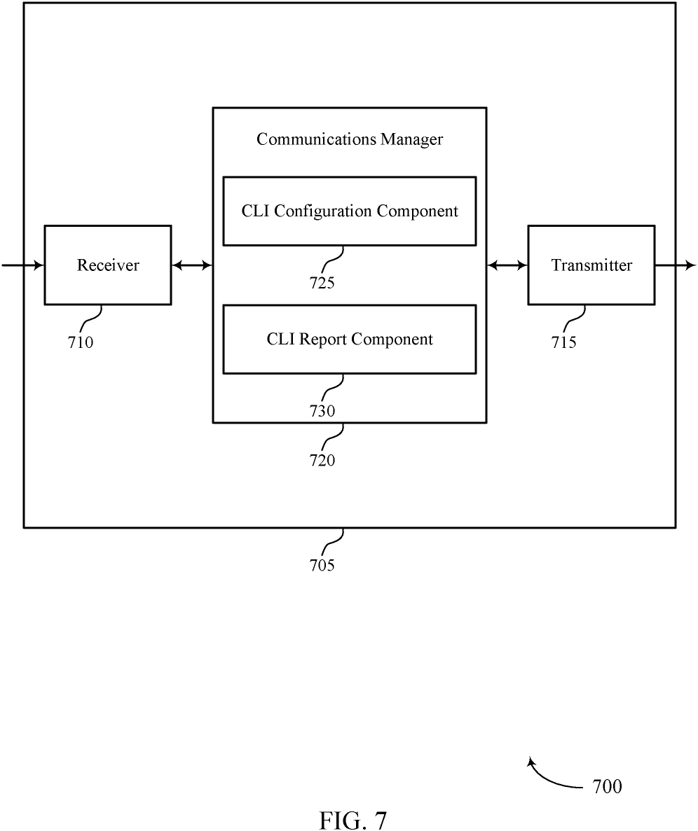

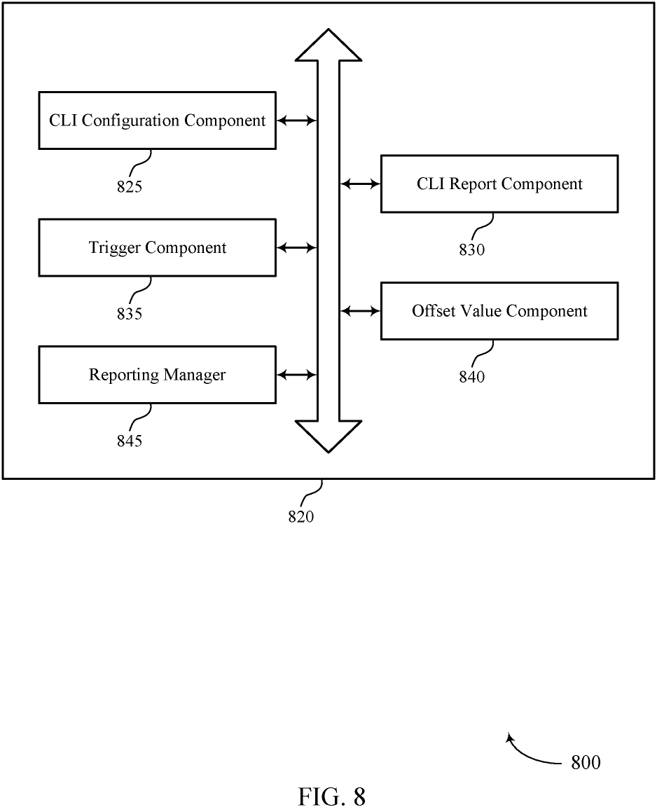

FIG. 7 shows a block diagram 700 of a device 705 that supports CLI reporting on physical uplink channels in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CLI reporting on physical uplink channels). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CLI reporting on physical uplink channels). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of CLI reporting on physical uplink channels as described herein. For example, the communications manager 720 may include a CLI configuration component 725 a CLI report component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. The CLI configuration component 725 may be configured as or otherwise support a means for receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The CLI report component 730 may be configured as or otherwise support a means for transmitting the CLI report on the physical uplink channel in accordance with the first set of rules and the second set of rules, the CLI report indicating one or more CLI measurements performed by the UE.

FIG. 8 shows a block diagram 800 of a communications manager 820 that supports CLI reporting on physical uplink channels in accordance with one or more aspects of the present disclosure. The communications manager 820 may be an example of aspects of a communications manager 620, a communications manager 720, or both, as described herein. The communications manager 820, or various components thereof, may be an example of means for performing various aspects of CLI reporting on physical uplink channels as described herein. For example, the communications manager 820 may include a CLI configuration component 825, a CLI report component 830, a trigger component 835, an offset value component 840, and a reporting manager 845, or any combination thereof. Each of these components may communicate, directly or indirectly, with one another (e.g., via one or more buses).

The communications manager 820 may support wireless communication at a UE in accordance with examples as disclosed herein. The CLI configuration component 825 may be configured as or otherwise support a means for receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The CLI report component 830 may be configured as or otherwise support a means for transmitting the CLI report on the physical uplink channel in accordance with the first set of rules and the second set of rules, the CLI report indicating one or more CLI measurements performed by the UE.

In some examples, the trigger component 835 may be configured as or otherwise support a means for receiving a second message that triggers the UE to report the one or more CLI measurements and includes an offset indicator, where transmitting the CLI report is based on receiving the second message. In some examples, the offset value component 840 may be configured as or otherwise support a means for determining one or more CLI offset values based on the offset indicator, where the quantity of resources is based on the one or more CLI offset values.

In some examples, to support determining the one or more CLI offset values, the offset value component 840 may be configured as or otherwise support a means for determining the one or more CLI offset values using the offset indicator and a table including a set of multiple CLI offset values. In some examples, to support determining the one or more CLI offset values, the offset value component 840 may be configured as or otherwise support a means for calculating the one or more CLI offset values using a difference from one or more CSI offset values.

In some examples, the CLI report configuration includes an indication of the difference. In some examples, calculating the one or more CLI offset values is based on receiving the first message. In some examples, the one or more CLI offset values are different than one or more CSI offset values.

In some examples, the offset value component 840 may be configured as or otherwise support a means for receiving a second message that indicates one or more CLI offset values, where the quantity of resources is based on the one or more CLI offset values. In some examples, the trigger component 835 may be configured as or otherwise support a means for receiving a third message that triggers the UE to report the one or more CLI measurements, where the third message is common to a group of two or more UEs including the UE, and where transmitting the CLI report is based on receiving the third message.

In some examples, the third message includes an offset indicator. In some examples, determining the one or more CLI offset values is further based on the offset indicator. In some examples, the CLI report component 830 may be configured as or otherwise support a means for multiplexing the CLI report on the physical uplink channel over the quantity of resources based on the second set of rules, the physical uplink channel including a PUSCH, where transmitting the CLI report is based on the multiplexing. In some examples, to support multiplexing the CLI report, the CLI report component 830 may be configured as or otherwise support a means for multiplexing the CLI report subsequent to a CSI report.

In some examples, to support multiplexing the CLI report, the reporting manager 845 may be configured as or otherwise support a means for multiplexing a first portion of the CLI report subsequent to a first portion of a CSI report. In some examples, to support multiplexing the CLI report, the reporting manager 845 may be configured as or otherwise support a means for multiplexing a second portion of the CLI report subsequent to a second portion of the CSI report.

In some examples, the CLI report component 830 may be configured as or otherwise support a means for receiving a second message indicating for the UE to multiplex the CLI report with feedback information. In some examples, the CLI report component 830 may be configured as or otherwise support a means for multiplexing the CLI report with the feedback information based on receiving the second message, the physical uplink channel including a PUCCH, where transmitting the CLI report is based on the multiplexing.

In some examples, the CLI report component 830 may be configured as or otherwise support a means for receiving a third message indicating for the UE to multiplex the CLI report with a CSI report, where multiplexing the CLI report with the feedback information includes. In some examples, the CLI report component 830 may be configured as or otherwise support a means for multiplexing the CLI report with the feedback information and the CSI report based on receiving the second message and the third message. In some examples, the CLI report is multiplexed subsequent to the feedback information and a first portion of the CSI report.

In some examples, to support multiplexing the CLI report with the feedback information and the CSI report, the CLI report component 830 may be configured as or otherwise support a means for multiplexing the CLI report with the feedback information and the CSI report in accordance with an ordering that is based on a respective priority of the CLI report and the CSI report.

In some examples, to support multiplexing the CLI report with the feedback information and the CSI report, the reporting manager 845 may be configured as or otherwise support a means for multiplexing the feedback information, a first portion of the CSI report, and a first portion of the CLI report. In some examples, to support multiplexing the CLI report with the feedback information and the CSI report, the reporting manager 845 may be configured as or otherwise support a means for dropping at least a second portion of the CLI report.

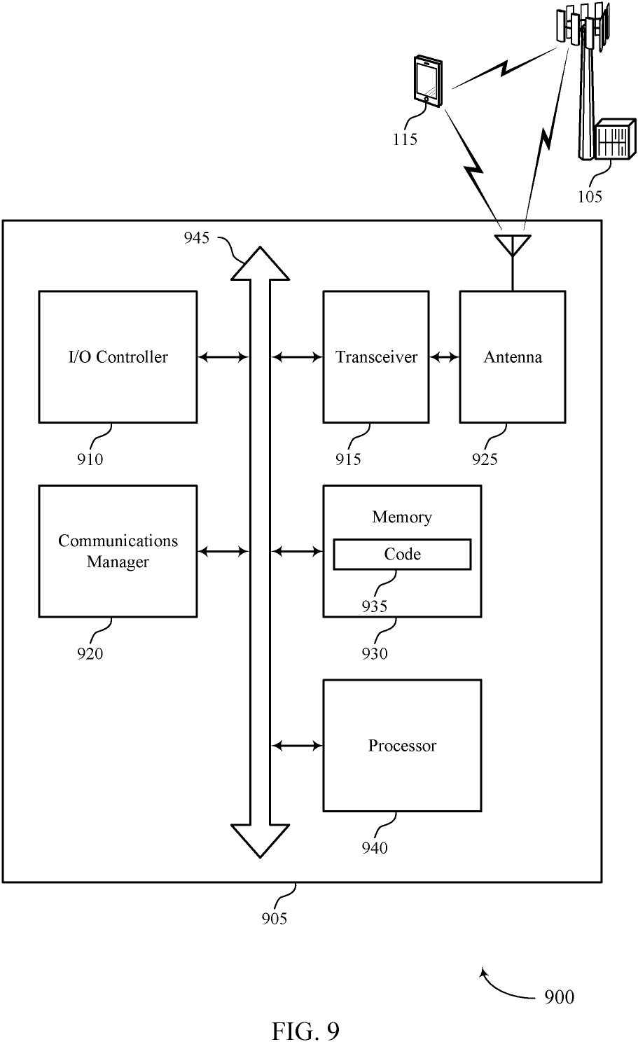

FIG. 9 shows a diagram of a system 900 including a device 905 that supports CLI reporting on physical uplink channels in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting CLI reporting on physical uplink channels). For example, the device 905 or a component of the device 905 may include a processor 940 and memory 930 coupled with or to the processor 940, the processor 940 and memory 930 configured to perform various functions described herein.

The communications manager 920 may support wireless communication at a UE (e.g., device 905) in accordance with examples as disclosed herein. For example, the communications manager 920 may be configured as or otherwise support a means for receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The communications manager 920 may be configured as or otherwise support a means for transmitting the CLI report on the physical uplink channel in accordance with the first set of rules and the second set of rules, the CLI report indicating one or more CLI measurements performed by the UE.

By including or configuring the communications manager 920 in accordance with examples as described herein, the device 905 may support techniques for improved communication reliability, reduced latency, more efficient utilization of communication resources, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of CLI reporting on physical uplink channels as described herein, or the processor 940 and the memory 930 may be otherwise configured to perform or support such operations.

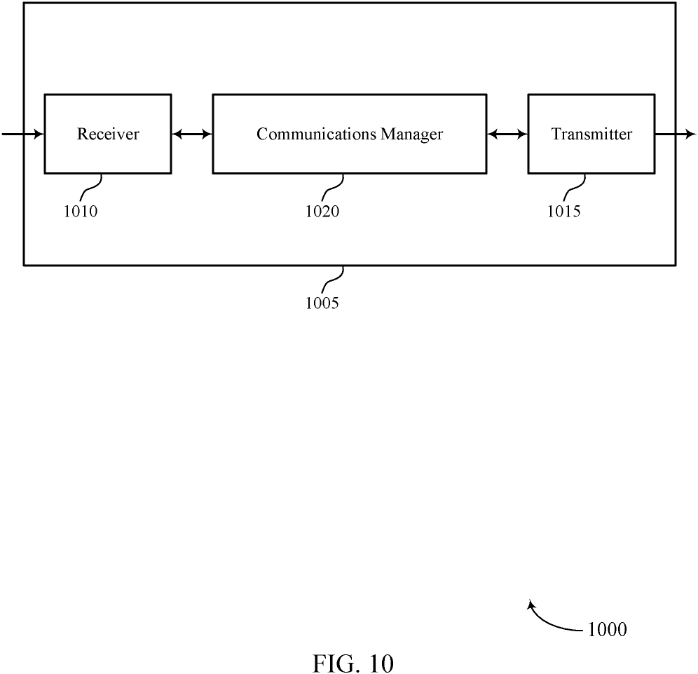

FIG. 10 shows a block diagram 1000 of a device 1005 that supports CLI reporting on physical uplink channels in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of CLI reporting on physical uplink channels as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity (e.g., the device 1005) in accordance with examples as disclosed herein. For example, the communications manager 1020 may be configured as or otherwise support a means for transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The communications manager 1020 may be configured as or otherwise support a means for receiving the CLI report on the physical uplink channel in accordance with the first set of rules and the second set of rules, the CLI report indicating one or more CLI measurements performed by a UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

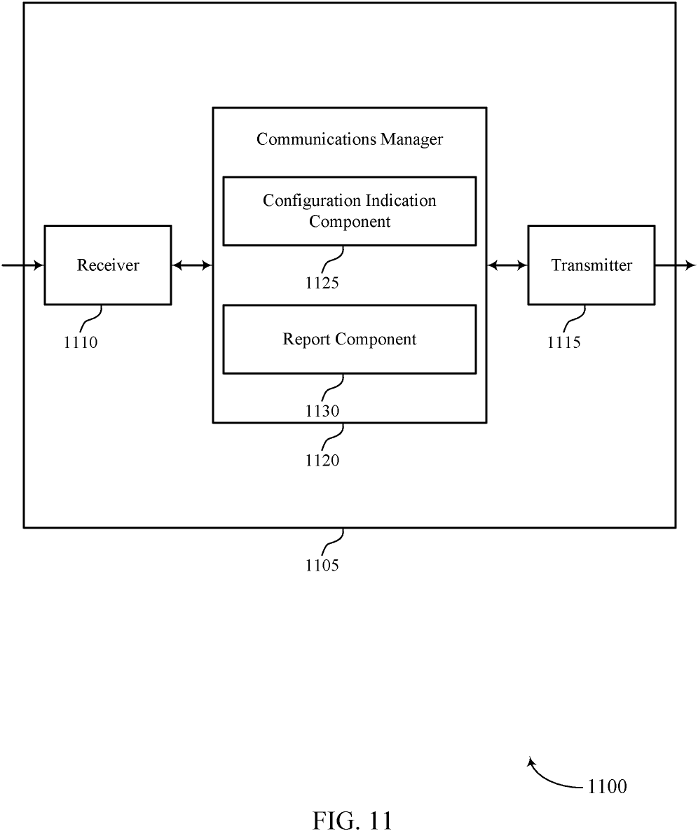

FIG. 11 shows a block diagram 1100 of a device 1105 that supports CLI reporting on physical uplink channels in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of CLI reporting on physical uplink channels as described herein. For example, the communications manager 1120 may include a configuration indication component 1125 a report component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. The configuration indication component 1125 may be configured as or otherwise support a means for transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The report component 1130 may be configured as or otherwise support a means for receiving the CLI report on the physical uplink channel in accordance with the first set of rules and the second set of rules, the CLI report indicating one or more CLI measurements performed by a UE.

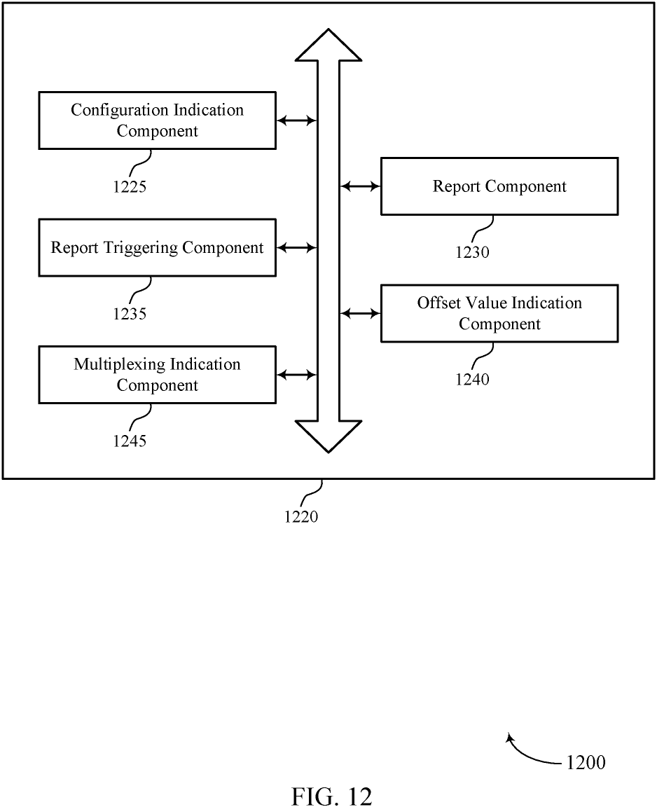

FIG. 12 shows a block diagram 1200 of a communications manager 1220 that supports CLI reporting on physical uplink channels in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of CLI reporting on physical uplink channels as described herein. For example, the communications manager 1220 may include a configuration indication component 1225, a report component 1230, a report triggering component 1235, an offset value indication component 1240, a multiplexing indication component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The configuration indication component 1225 may be configured as or otherwise support a means for transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The report component 1230 may be configured as or otherwise support a means for receiving the CLI report on the physical uplink channel in accordance with the first set of rules and the second set of rules, the CLI report indicating one or more CLI measurements performed by a UE.

In some examples, the report triggering component 1235 may be configured as or otherwise support a means for transmitting a second message that triggers the UE to report the one or more CLI measurements and includes an offset indicator, where receiving the CLI report is based on receiving the second message, and where the quantity of resources is based on one or more CLI offset values indicated by the offset indicator.

In some examples, the one or more CLI offset values indicated by the offset indicator correspond to CLI offset values included in a table. In some examples, the one or more CLI offset values indicated by the offset indicator are based on a difference from one or more CSI offset values.

In some examples, the CLI report configuration includes an indication of the difference. In some examples, the one or more CLI offset values are different than one or more CSI offset values.

In some examples, the offset value indication component 1240 may be configured as or otherwise support a means for transmitting a second message that indicates one or more CLI offset values, where the quantity of resources is based on the one or more CLI offset values. In some examples, the report triggering component 1235 may be configured as or otherwise support a means for transmitting a third message that triggers the UE to report the one or more CLI measurements, where the third message is common to a group of two or more UEs including the UE, and where receiving the CLI report is based on the third message.

In some examples, the third message includes an offset indicator. In some examples, the one or more CLI offset values are based on the offset indicator. In some examples, the CLI report is multiplexed on the physical uplink channel over the quantity of resources subsequent to a CSI report and based on the second set of rules.

In some examples, a first portion of the CLI report is multiplexed on the physical uplink channel over the quantity of resources subsequent to a first portion of a CSI report and based on the second set of rules. In some examples, a second portion of the CLI report is multiplexed on the physical uplink channel over the quantity of resources subsequent to a second portion of the CSI report.

In some examples, the multiplexing indication component 1245 may be configured as or otherwise support a means for transmitting a second message indicating for the UE to multiplex the CLI report with feedback information, where the CLI report is multiplexed with the feedback information based on the second message.

In some examples, the multiplexing indication component 1245 may be configured as or otherwise support a means for transmitting a third message indicating for the UE to multiplex the CLI report with a CSI report, where the CLI report is multiplexed with the feedback information and the CSI report based on the third message.

In some examples, the CLI report is multiplexed subsequent to the feedback information and a first portion of the CSI report. In some examples, the CLI report is multiplexed with the feedback information and the CSI report according to an ordering that is based on a respective priority of the CLI report and the CSI report.

In some examples, the feedback information, a first portion of the CSI report, and a first portion of the CLI report are multiplexed on the physical uplink channel. In some examples, at least a portion of a second portion of the CLI report is dropped.

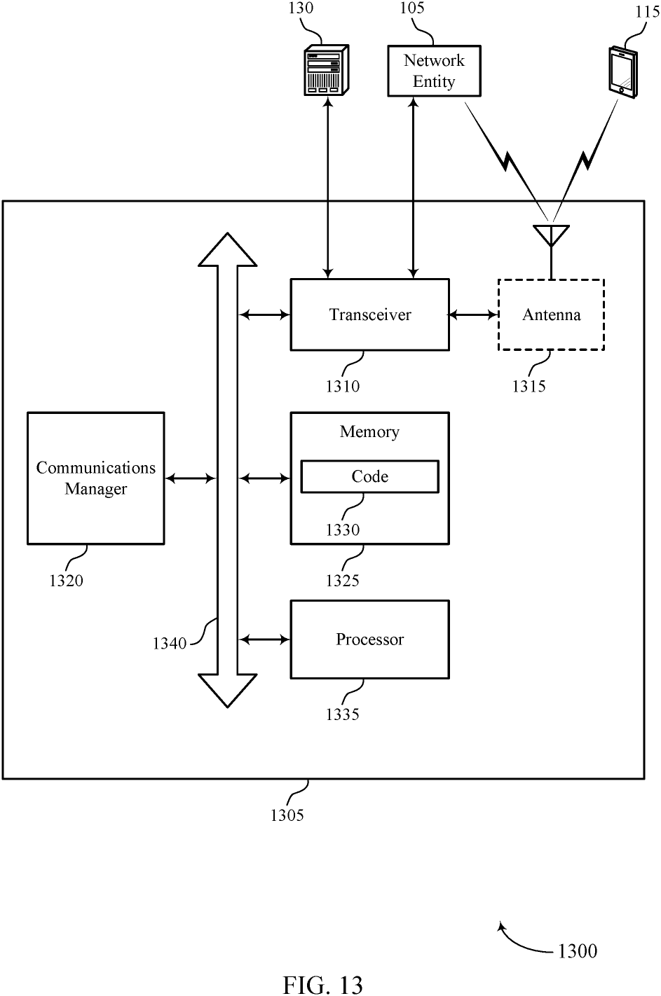

FIG. 13 shows a diagram of a system 1300 including a device 1305 that supports CLI reporting on physical uplink channels in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting CLI reporting on physical uplink channels). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity (e.g., the device 1305) in accordance with examples as disclosed herein. For example, the communications manager 1320 may be configured as or otherwise support a means for transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The communications manager 1320 may be configured as or otherwise support a means for receiving the CLI report on the physical uplink channel in accordance with the first set of rules and the second set of rules, the CLI report indicating one or more CLI measurements performed by a UE.

By including or configuring the communications manager 1320 in accordance with examples as described herein, the device 1305 may support techniques for improved communication reliability, reduced latency, more efficient utilization of communication resources, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of CLI reporting on physical uplink channels as described herein, or the processor 1335 and the memory 1325 may be otherwise configured to perform or support such operations.

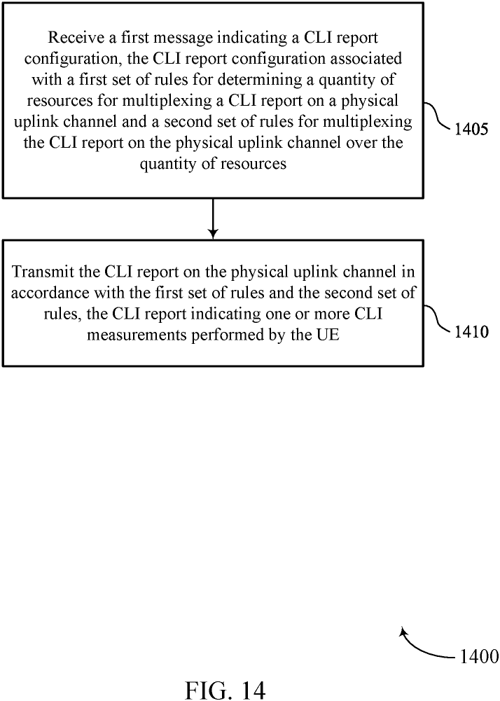

FIG. 14 shows a flowchart illustrating a method 1400 that supports CLI reporting on physical uplink channels in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The operations of 1405 may be performed in accordance with examples as disclosed herein. In some examples, aspects of the operations of 1405 may be performed by a CLI configuration component 825 as described with reference to FIG. 8.

At 1410, the method may include transmitting the CLI report on the physical uplink channel in accordance with the first set of rules and the second set of rules, the CLI report indicating one or more CLI measurements performed by the UE. The operations of 1410 may be performed in accordance with examples as disclosed herein. In some examples, aspects of the operations of 1410 may be performed by a CLI report component 830 as described with reference to FIG. 8.

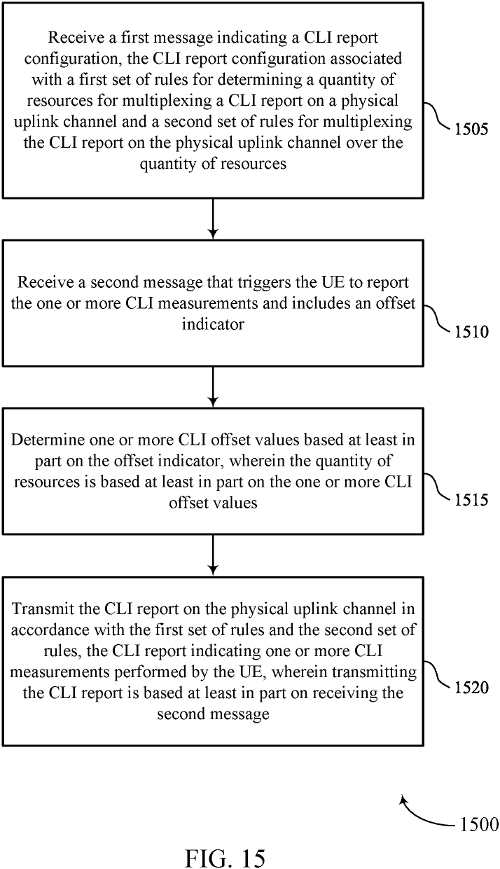

FIG. 15 shows a flowchart illustrating a method 1500 that supports CLI reporting on physical uplink channels in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The operations of 1505 may be performed in accordance with examples as disclosed herein. In some examples, aspects of the operations of 1505 may be performed by a CLI configuration component 825 as described with reference to FIG. 8.

At 1510, the method may include receiving a second message that triggers the UE to report the one or more CLI measurements and includes an offset indicator. The operations of 1510 may be performed in accordance with examples as disclosed herein. In some examples, aspects of the operations of 1510 may be performed by a trigger component 835 as described with reference to FIG. 8.

At 1515, the method may include determining one or more CLI offset values based on the offset indicator, where the quantity of resources is based on the one or more CLI offset values. The operations of 1515 may be performed in accordance with examples as disclosed herein. In some examples, aspects of the operations of 1515 may be performed by an offset value component 840 as described with reference to FIG. 8.

At 1520, the method may include transmitting the CLI report on the physical uplink channel in accordance with the first set of rules and the second set of rules, the CLI report indicating one or more CLI measurements performed by the UE, where transmitting the CLI report is based on receiving the second message. The operations of 1520 may be performed in accordance with examples as disclosed herein. In some examples, aspects of the operations of 1520 may be performed by a CLI report component 830 as described with reference to FIG. 8.

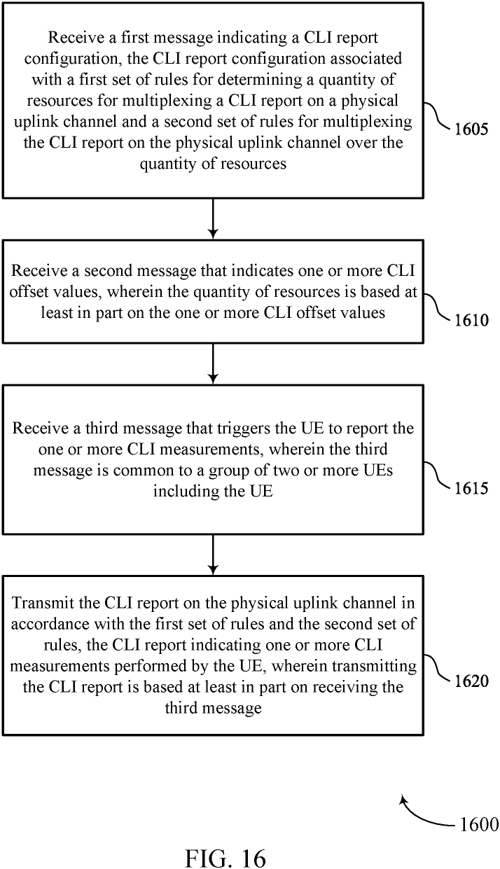

FIG. 16 shows a flowchart illustrating a method 1600 that supports CLI reporting on physical uplink channels in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The operations of 1605 may be performed in accordance with examples as disclosed herein. In some examples, aspects of the operations of 1605 may be performed by a CLI configuration component 825 as described with reference to FIG. 8.

At 1610, the method may include receiving a second message that indicates one or more CLI offset values, where the quantity of resources is based on the one or more CLI offset values. The operations of 1610 may be performed in accordance with examples as disclosed herein. In some examples, aspects of the operations of 1610 may be performed by an offset value component 840 as described with reference to FIG. 8.

At 1615, the method may include receiving a third message that triggers the UE to report the one or more CLI measurements, where the third message is common to a group of two or more UEs including the UE. The operations of 1615 may be performed in accordance with examples as disclosed herein. In some examples, aspects of the operations of 1615 may be performed by a trigger component 835 as described with reference to FIG. 8.

At 1620, the method may include transmitting the CLI report on the physical uplink channel in accordance with the first set of rules and the second set of rules, the CLI report indicating one or more CLI measurements performed by the UE, and where transmitting the CLI report is based on receiving the third message. The operations of 1620 may be performed in accordance with examples as disclosed herein. In some examples, aspects of the operations of 1620 may be performed by a CLI report component 830 as described with reference to FIG. 8.

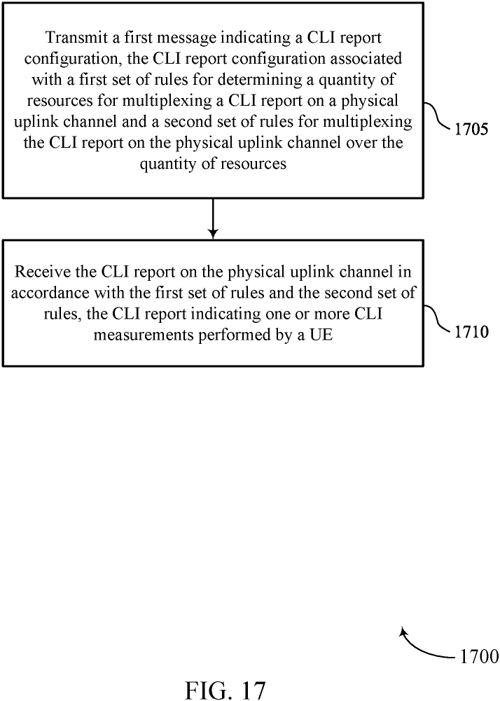

FIG. 17 shows a flowchart illustrating a method 1700 that supports CLI reporting on physical uplink channels in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The operations of 1705 may be performed in accordance with examples as disclosed herein. In some examples, aspects of the operations of 1705 may be performed by a configuration indication component 1225 as described with reference to FIG. 12.

At 1710, the method may include receiving the CLI report on the physical uplink channel in accordance with the first set of rules and the second set of rules, the CLI report indicating one or more CLI measurements performed by a UE. The operations of 1710 may be performed in accordance with examples as disclosed herein. In some examples, aspects of the operations of 1710 may be performed by a report component 1230 as described with reference to FIG. 12.

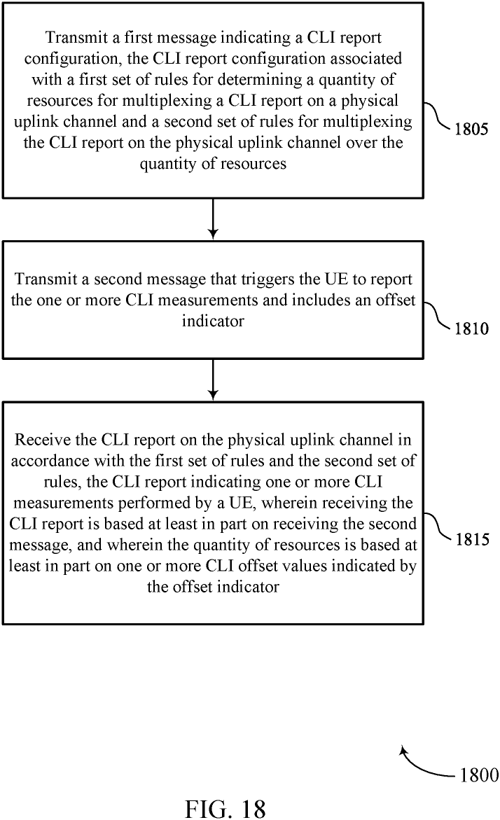

FIG. 18 shows a flowchart illustrating a method 1800 that supports CLI reporting on physical uplink channels in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The operations of 1805 may be performed in accordance with examples as disclosed herein. In some examples, aspects of the operations of 1805 may be performed by a configuration indication component 1225 as described with reference to FIG. 12.

At 1810, the method may include transmitting a second message that triggers the UE to report the one or more CLI measurements and includes an offset indicator. The operations of 1810 may be performed in accordance with examples as disclosed herein. In some examples, aspects of the operations of 1810 may be performed by a report triggering component 1235 as described with reference to FIG. 12.

At 1815, the method may include receiving the CLI report on the physical uplink channel in accordance with the first set of rules and the second set of rules, the CLI report indicating one or more CLI measurements performed by a UE, where receiving the CLI report is based on receiving the second message, and where the quantity of resources is based on one or more CLI offset values indicated by the offset indicator. The operations of 1815 may be performed in accordance with examples as disclosed herein. In some examples, aspects of the operations of 1815 may be performed by a report component 1230 as described with reference to FIG. 12.

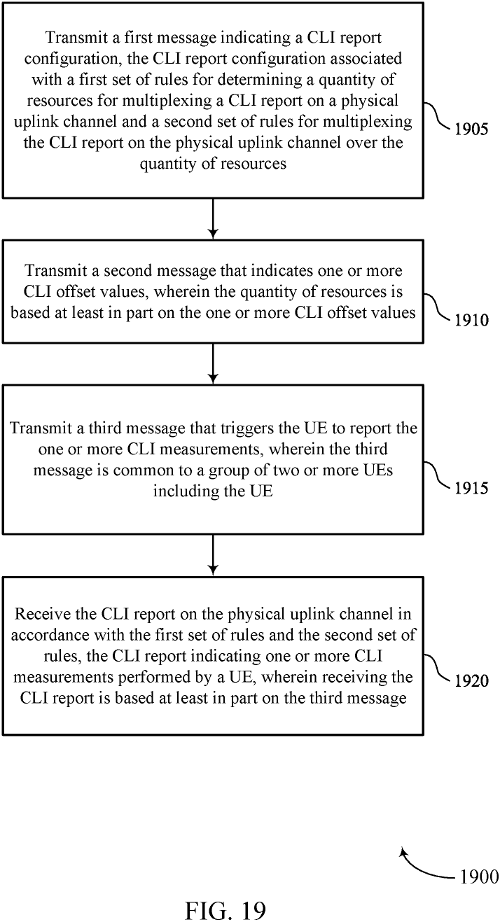

FIG. 19 shows a flowchart illustrating a method 1900 that supports CLI reporting on physical uplink channels in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources. The operations of 1905 may be performed in accordance with examples as disclosed herein. In some examples, aspects of the operations of 1905 may be performed by a configuration indication component 1225 as described with reference to FIG. 12.

At 1910, the method may include transmitting a second message that indicates one or more CLI offset values, where the quantity of resources is based on the one or more CLI offset values. The operations of 1910 may be performed in accordance with examples as disclosed herein. In some examples, aspects of the operations of 1910 may be performed by an offset value indication component 1240 as described with reference to FIG. 12.

At 1915, the method may include transmitting a third message that triggers the UE to report the one or more CLI measurements, where the third message is common to a group of two or more UEs including the UE. The operations of 1915 may be performed in accordance with examples as disclosed herein. In some examples, aspects of the operations of 1915 may be performed by a report triggering component 1235 as described with reference to FIG. 12.

At 1920, the method may include receiving the CLI report on the physical uplink channel in accordance with the first set of rules and the second set of rules, the CLI report indicating one or more CLI measurements performed by a UE, where receiving the CLI report is based on the third message. The operations of 1920 may be performed in accordance with examples as disclosed herein. In some examples, aspects of the operations of 1920 may be performed by a report component 1230 as described with reference to FIG. 12.

The following provides an overview of aspects of the present disclosure:

Aspect 1: A method for wireless communication at a UE, comprising: receiving a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources; and transmitting the CLI report on the physical uplink channel in accordance with the first set of rules and the second set of rules, the CLI report indicating one or more CLI measurements performed by the UE.

Aspect 2: The method of aspect 1, further comprising: receiving a second message that triggers the UE to report the one or more CLI measurements and includes an offset indicator, wherein transmitting the CLI report is based at least in part on receiving the second message; and determining one or more CLI offset values based at least in part on the offset indicator, wherein the quantity of resources is based at least in part on the one or more CLI offset values.

Aspect 3: The method of aspect 2, wherein determining the one or more CLI offset values comprises: determining the one or more CLI offset values using the offset indicator and a table comprising a plurality of CLI offset values.

Aspect 4: The method of aspect 2, wherein determining the one or more CLI offset values comprises: calculating the one or more CLI offset values using a difference from one or more CSI offset values.

Aspect 5: The method of aspect 4, wherein the CLI report configuration comprises an indication of the difference, and calculating the one or more CLI offset values is based at least in part on receiving the first message.

Aspect 6: The method of any of aspects 2 through 5, wherein the one or more CLI offset values are different than one or more CSI offset values.

Aspect 7: The method of aspect 1, further comprising: receiving a second message that indicates one or more CLI offset values, wherein the quantity of resources is based at least in part on the one or more CLI offset values; and receiving a third message that triggers the UE to report the one or more CLI measurements, wherein the third message is common to a group of two or more UEs including the UE, and wherein transmitting the CLI report is based at least in part on receiving the third message.

Aspect 8: The method of aspect 7, wherein the third message includes an offset indicator, and determining the one or more CLI offset values is further based at least in part on the offset indicator.

Aspect 9: The method of any of aspects 1 through 8, further comprising: multiplexing the CLI report on the physical uplink channel over the quantity of resources based at least in part on the second set of rules, the physical uplink channel comprising a PUSCH, wherein transmitting the CLI report is based at least in part on the multiplexing.

Aspect 10: The method of aspect 9, wherein multiplexing the CLI report comprises: multiplexing the CLI report subsequent to a CSI report.

Aspect 11: The method of aspect 9, wherein multiplexing the CLI report comprises: multiplexing a first portion of the CLI report subsequent to a first portion of a CSI report; and multiplexing a second portion of the CLI report subsequent to a second portion of the CSI report.

Aspect 12: The method of any of aspects 1 through 8, further comprising: receiving a second message indicating for the UE to multiplex the CLI report with feedback information; and multiplexing the CLI report with the feedback information based at least in part on receiving the second message, the physical uplink channel comprising a PUCCH, wherein transmitting the CLI report is based at least in part on the multiplexing.

Aspect 13: The method of aspect 12, further comprising: receiving a third message indicating for the UE to multiplex the CLI report with a CSI report, wherein multiplexing the CLI report with the feedback information comprises: multiplexing the CLI report with the feedback information and the CSI report based at least in part on receiving the second message and the third message.

Aspect 14: The method of aspect 13, wherein the CLI report is multiplexed subsequent to the feedback information and a first portion of the CSI report.

Aspect 15: The method of aspect 13, wherein multiplexing the CLI report with the feedback information and the CSI report comprises: multiplexing the CLI report with the feedback information and the CSI report in accordance with an ordering that is based at least in part on a respective priority of the CLI report and the CSI report.

Aspect 16: The method of aspect 13, wherein multiplexing the CLI report with the feedback information and the CSI report comprises: multiplexing the feedback information, a first portion of the CSI report, and a first portion of the CLI report; and dropping at least a second portion of the CLI report.

Aspect 17: A method for wireless communication at a network entity, comprising: transmitting a first message indicating a CLI report configuration, the CLI report configuration associated with a first set of rules for determining a quantity of resources for multiplexing a CLI report on a physical uplink channel and a second set of rules for multiplexing the CLI report on the physical uplink channel over the quantity of resources; and receiving the CLI report on the physical uplink channel in accordance with the first set of rules and the second set of rules, the CLI report indicating one or more CLI measurements performed by a UE.

Aspect 18: The method of aspect 17, further comprising: transmitting a second message that triggers the UE to report the one or more CLI measurements and includes an offset indicator, wherein receiving the CLI report is based at least in part on receiving the second message, and wherein the quantity of resources is based at least in part on one or more CLI offset values indicated by the offset indicator.

Aspect 19: The method of aspect 18, wherein the one or more CLI offset values indicated by the offset indicator correspond to CLI offset values included in a table.

Aspect 20: The method of aspect 18, wherein the one or more CLI offset values indicated by the offset indicator are based at least in part on a difference from one or more CSI offset values.

Aspect 21: The method of aspect 20, wherein the CLI report configuration comprises an indication of the difference.

Aspect 22: The method of any of aspects 18 through 21, wherein the one or more CLI offset values are different than one or more CSI offset values.

Aspect 23: The method of aspect 17, further comprising: transmitting a second message that indicates one or more CLI offset values, wherein the quantity of resources is based at least in part on the one or more CLI offset values; and transmitting a third message that triggers the UE to report the one or more CLI measurements, wherein the third message is common to a group of two or more UEs including the UE, and wherein receiving the CLI report is based at least in part on the third message.

Aspect 24: The method of aspect 23, wherein the third message includes an offset indicator, and the one or more CLI offset values are based at least in part on the offset indicator.

Aspect 25: The method of any of aspects 17 through 24, wherein the CLI report is multiplexed on the physical uplink channel over the quantity of resources subsequent to a CSI report and based at least in part on the second set of rules.

Aspect 26: The method of any of aspects 17 through 24, wherein a first portion of the CLI report is multiplexed on the physical uplink channel over the quantity of resources subsequent to a first portion of a CSI report and based at least in part on the second set of rules, and a second portion of the CLI report is multiplexed on the physical uplink channel over the quantity of resources subsequent to a second portion of the CSI report.

Aspect 27: The method of any of aspects 17 through 24, further comprising: transmitting a second message indicating for the UE to multiplex the CLI report with feedback information, wherein the CLI report is multiplexed with the feedback information based at least in part on the second message.

Aspect 28: The method of aspect 27, further comprising: transmitting a third message indicating for the UE to multiplex the CLI report with a CSI report, wherein the CLI report is multiplexed with the feedback information and the CSI report based at least in part on the third message.

Aspect 29: The method of aspect 28, wherein the CLI report is multiplexed subsequent to the feedback information and a first portion of the CSI report.

Aspect 30: The method of aspect 28, wherein the CLI report is multiplexed with the feedback information and the CSI report according to an ordering that is based at least in part on a respective priority of the CLI report and the CSI report.

Aspect 31: The method of aspect 28, wherein the feedback information, a first portion of the CSI report, and a first portion of the CLI report are multiplexed on the physical uplink channel, and at least a portion of a second portion of the CLI report is dropped.

Aspect 32: An apparatus for wireless communication at a UE, comprising a processor; memory coupled with the processor; and instructions stored in the memory and executable by the processor to cause the apparatus to perform a method of any of aspects 1 through 16.

Aspect 33: An apparatus for wireless communication at a UE, comprising at least one means for performing a method of any of aspects 1 through 16.

Aspect 34: A non-transitory computer-readable medium storing code for wireless communication at a UE, the code comprising instructions executable by a processor to perform a method of any of aspects 1 through 16.

Aspect 35: An apparatus for wireless communication at a network entity, comprising a processor; memory coupled with the processor; and instructions stored in the memory and executable by the processor to cause the apparatus to perform a method of any of aspects 17 through 31.

Aspect 36: An apparatus for wireless communication at a network entity, comprising at least one means for performing a method of any of aspects 17 through 31.

Aspect 37: A non-transitory computer-readable medium storing code for wireless communication at a network entity, the code comprising instructions executable by a processor to perform a method of any of aspects 17 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or FEC AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first message indicating a cross-link interference report configuration, the cross-link interference report configuration associated with a first set of rules for determining a quantity of resources for multiplexing a cross-link interference report on a physical uplink channel and a second set of rules for multiplexing the cross-link interference report on the physical uplink channel over the quantity of resources; and
transmitting the cross-link interference report on the physical uplink channel in accordance with the first set of rules and the second set of rules, the cross-link interference report indicating one or more cross-link interference measurements performed by the UE.

2. The method of claim 1, further comprising:
receiving a second message that triggers the UE to report the one or more cross-link interference measurements and includes an offset indicator, wherein transmitting the cross-link interference report is based at least in part on receiving the second message; and
determining one or more cross-link interference offset values based at least in part on the offset indicator, wherein the quantity of resources is based at least in part on the one or more cross-link interference offset values.

3. The method of claim 2, wherein determining the one or more cross-link interference offset values comprises:
determining the one or more cross-link interference offset values using the offset indicator and a table comprising a plurality of cross-link interference offset values.

4. The method of claim 2, wherein determining the one or more cross-link interference offset values comprises:
calculating the one or more cross-link interference offset values using a difference from one or more channel state information offset values.

5. The method of claim 4, wherein the cross-link interference report configuration comprises an indication of the difference, and calculating the one or more cross-link interference offset values is based at least in part on receiving the first message.

6. The method of claim 2, wherein the one or more cross-link interference offset values are different than one or more channel state information offset values.

7. The method of claim 1, further comprising:
receiving a second message that indicates one or more cross-link interference offset values, wherein the quantity of resources is based at least in part on the one or more cross-link interference offset values; and
receiving a third message that triggers the UE to report the one or more cross-link interference measurements, wherein the third message is common to a group of two or more UEs including the UE, and wherein transmitting the cross-link interference report is based at least in part on receiving the third message.

8. The method of claim 7, wherein the third message includes an offset indicator, and determining the one or more cross-link interference offset values is further based at least in part on the offset indicator.

9. The method of claim 1, further comprising:
multiplexing the cross-link interference report on the physical uplink channel over the quantity of resources based at least in part on the second set of rules, the physical uplink channel comprising a physical uplink shared channel, wherein transmitting the cross-link interference report is based at least in part on the multiplexing.

10. The method of claim 9, wherein multiplexing the cross-link interference report comprises:
multiplexing the cross-link interference report subsequent to a channel state information report.

11. The method of claim 9, wherein multiplexing the cross-link interference report comprises:
multiplexing a first portion of the cross-link interference report subsequent to a first portion of a channel state information report; and
multiplexing a second portion of the cross-link interference report subsequent to a second portion of the channel state information report.

12. The method of claim 1, further comprising:
receiving a second message indicating for the UE to multiplex the cross-link interference report with feedback information; and
multiplexing the cross-link interference report with the feedback information based at least in part on receiving the second message, the physical uplink channel comprising a physical uplink control channel, wherein transmitting the cross-link interference report is based at least in part on the multiplexing.

13. The method of claim 12, further comprising:
receiving a third message indicating for the UE to multiplex the cross-link interference report with a channel state information report, wherein multiplexing the cross-link interference report with the feedback information comprises:
multiplexing the cross-link interference report with the feedback information and the channel state information report based at least in part on receiving the second message and the third message.

14. The method of claim 13, wherein the cross-link interference report is multiplexed subsequent to the feedback information and a first portion of the channel state information report.

15. The method of claim 13, wherein multiplexing the cross-link interference report with the feedback information and the channel state information report comprises:
multiplexing the cross-link interference report with the feedback information and the channel state information report in accordance with an ordering that is based at least in part on a respective priority of the cross-link interference report and the channel state information report.

16. The method of claim 13, wherein multiplexing the cross-link interference report with the feedback information and the channel state information report comprises:
multiplexing the feedback information, a first portion of the channel state information report, and a first portion of the cross-link interference report; and dropping at least a second portion of the cross-link interference report.

17. A method for wireless communication at a network entity, comprising:
transmitting a first message indicating a cross-link interference report configuration, the cross-link interference report configuration associated with a first set of rules for determining a quantity of resources for multiplexing a cross-link interference report on a physical uplink channel and a second set of rules for multiplexing the cross-link interference report on the physical uplink channel over the quantity of resources; and
receiving the cross-link interference report on the physical uplink channel in accordance with the first set of rules and the second set of rules, the cross-link interference report indicating one or more cross-link interference measurements performed by a user equipment (UE).

18. The method of claim 17, further comprising:
transmitting a second message that triggers the UE to report the one or more cross-link interference measurements and includes an offset indicator, wherein receiving the cross-link interference report is based at least in part on receiving the second message, and wherein the quantity of resources is based at least in part on one or more cross-link interference offset values indicated by the offset indicator.

19. The method of claim 18, wherein the one or more cross-link interference offset values indicated by the offset indicator correspond to cross-link interference offset values included in a table.

20. The method of claim 18, wherein the one or more cross-link interference offset values indicated by the offset indicator are based at least in part on a difference from one or more channel state information offset values.

21. The method of claim 20, wherein the cross-link interference report configuration comprises an indication of the difference.

22. The method of claim 17, further comprising:
transmitting a second message that indicates one or more cross-link interference offset values, wherein the quantity of resources is based at least in part on the one or more cross-link interference offset values; and
transmitting a third message that triggers the UE to report the one or more cross-link interference measurements, wherein the third message is common to a group of two or more UEs including the UE, and wherein receiving the cross-link interference report is based at least in part on the third message.

23. The method of claim 22, wherein the third message includes an offset indicator, and the one or more cross-link interference offset values are based at least in part on the offset indicator.

24. The method of claim 17, wherein the cross-link interference report is multiplexed on the physical uplink channel over the quantity of resources subsequent to a channel state information report and based at least in part on the second set of rules.

25. The method of claim 17, wherein a first portion of the cross-link interference report is multiplexed on the physical uplink channel over the quantity of resources subsequent to a first portion of a channel state information report and based at least in part on the second set of rules, and a second portion of the cross-link interference report is multiplexed on the physical uplink channel over the quantity of resources subsequent to a second portion of the channel state information report.

26. The method of claim 17, further comprising:
transmitting a second message indicating for the UE to multiplex the cross-link interference report with feedback information, wherein the cross-link interference report is multiplexed with the feedback information based at least in part on the second message.

27. The method of claim 26, further comprising:
transmitting a third message indicating for the UE to multiplex the cross-link interference report with a channel state information report, wherein the cross-link interference report is multiplexed with the feedback information and the channel state information report based at least in part on the third message.

28. The method of claim 27, wherein the cross-link interference report is multiplexed with the feedback information and the channel state information report according to an ordering that is based at least in part on a respective priority of the cross-link interference report and the channel state information report.

29. An apparatus for wireless communication at a user equipment (UE), comprising:
a processor;
memory coupled with the processor; and
instructions stored in the memory and executable by the processor to cause the apparatus to:
receive a first message indicating a cross-link interference report configuration, the cross-link interference report configuration associated with a first set of rules for determining a quantity of resources for multiplexing a cross-link interference report on a physical uplink channel and a second set of rules for multiplexing the cross-link interference report on the physical uplink channel over the quantity of resources; and
transmit the cross-link interference report on the physical uplink channel in accordance with the first set of rules and the second set of rules, the cross-link interference report indicating one or more cross-link interference measurements performed by the UE.

30. An apparatus for wireless communication at a network entity, comprising:
a processor;
memory coupled with the processor; and
instructions stored in the memory and executable by the processor to cause the apparatus to:
transmit a first message indicating a cross-link interference report configuration, the cross-link interference report configuration associated with a first set of rules for determining a quantity of resources for multiplexing a cross-link interference report on a physical uplink channel and a second set of rules for multiplexing the cross-link interference report on the physical uplink channel over the quantity of resources; and
receive the cross-link interference report on the physical uplink channel in accordance with the first set of rules and the second set of rules, the cross-link interference report indicating one or more cross-link interference measurements performed by a user equipment (UE).
